(19) United States
(12) Patent Application Publication
(10) Pub. No.: US 2026/0123658 A1
(43) Pub. Date: May 7, 2026

(54) Methods of Increasing the Beneficial Properties of Fermented Foods

(71) Applicant: The Brd. of Trustees of the Univ. of Illinois, Urbana, IL (US)

(72) Inventors: Jacob Matthew Allen, Champaign, IL (US); Michael J. Miller, Champaign, IL (US); Mikaela Kasperek, Decatur, IL (US)

(73) Assignee: The Brd. of Trustees of the Univ. of Illinois, Urbana, IL (US)

(21) Appl. No.: 19/381,643

(22) Filed: Nov. 6, 2025

Related U.S. Application Data
(60) Provisional application No. 63/716,826, filed on Nov. 6, 2024.

(51) Int. Cl. A23L 33/10; A23C 9/123; A23L 19/20; A23L 33/135; A23L 33/175

(52) U.S. Cl. CPC A23L 33/10; A23C 9/1234; A23L 19/20; A23L 33/135; A23L 33/175; A23V 2400/169; A23V 2400/529

(57) ABSTRACT

Provided herein are compositions and methods for increasing the amount aryl-lactates in fermented foods. The methods can comprise delivering alpha-ketoglutarate (AKG), trisodium citrate dehydrate (CIT), or both AKG and CIT; and/or phenylpyruvic acid (PPyA), 4-hydroxyphenylpyruvic acid (4HPPyA), indole-3-pyruvic acid (IPyA) or combinations thereof; and/or phenylalanine (Phe), tyrosine (Tyr), and/or tryptophan or combinations thereof to fermented foods and fermented food matrices. Optionally, bacteria with aromatic amino transferase (ArAT) and/or phenyllactate dehydrogenase activity can also be added to the fermented foods and fermented food matrices. Also provided are methods to increase the bioactivity of fermented foods towards an immune receptor (aryl hydrocarbon receptor—AhR). Also provided are methods to more effectively maintain food matrix AhR bioactivity across food storage times of up to 4 weeks. Also provided are methods of inducing weight loss, reducing fat mass, and/or reducing glucose intolerance in mammals.

### PRIORITY

This application claims the benefit of U.S. Ser. No. 63/716,826, filed on Nov. 6, 2024, and which is incorporated by reference herein in its entirety.

### GOVERNMENT SUPPORT

This invention was made with government support under 2023-67017-39053 awarded by US Department of Agriculture (National Institute of Food and Agriculture). The government has certain rights in the invention.

### BACKGROUND

The process of fermenting foods has traditionally been utilized to extend shelf life of perishable items, but more recently has been investigated for its proposed health-promoting effects upon consumption. Fermented foods contain desired microbial growth and enzymatic conversions resulting in transformation of food components. Various fermented foods are commercially available including dairy ferments such as yogurt and kefir, vegetable ferments including sauerkraut and kimchi, fermented tea (kombucha), and even fermented meats like salami. Fermentation involves either initiation with starter culture or independent (wild/spontaneous) fermentation, often involving lactic acid bacteria (LAB).

Methods are needed in the art to advance the beneficial properties of fermented foods and maintain these beneficial properties during food storage.

### SUMMARY

An aspect provides a method of increasing aryl-lactates in a fermented food matrix. The method comprises adding (a) alpha-ketoglutarate (AKG), trisodium citrate dehydrate (CIT), or both AKG and CIT; or (b) phenylpyruvic acid (PPyA), 4-hydroxyphenylpyruvic acid (4HPPyA), indole-3-pyruvic acid (IPyA), or combinations thereof; or (c) aromatic amino acids (ArAA) such as phenylalanine (Phe), Tyrosine (Tyr), Tryptophan (Trp), or combinations thereof; or (d) combinations of (a), (b), and (c); to (i) a pre-fermentation food matrix and allowing the pre-fermentation food matrix to ferment to form a fermented food matrix having increased amounts of aryl-lactates in comparison to a control; or (ii) a pre-fermentation food matrix after the beginning of fermentation and allowing the pre-fermentation food matrix to ferment to form a fermented food matrix having increased amounts of aryl-lactates in comparison to a control; or (iii) to a fermented food matrix after the end of fermentation to form a fermented food matrix having increased amounts of aryl-lactates in comparison to a control. The aryl-lactates can comprise phenyllactic acid (PLA), 4-hydroxyphenyllactic acid (4-HPLA), indole-lactic acid (ILA), or combinations thereof. The PPyA, 4HPPyA, IPyA, or combinations thereof can each be added at an amount of 0.5-5 mM. The AKG, CIT, or both can each be added at an amount of 0.5-5 mM. The aromatic amino acids (e.g., Phe, Tyr, and/or Trp) or combinations thereof can each be added at an amount of about 0.2-2.5 mg/mL or about 0.5 to 15 mM. The method can further comprise adding one or more bacterial strains having aromatic amino transferase (ArAT) activity and/or phenyllactate dehydrogenase (fLDH) activity. The one or more bacterial strains can be Lactiplantibacillus plantarum and/or Bifidobacterium infantis. The one or more bacterial strains can be Lactiplantibacillus plantarum, Lactobacillus rhamnosus, Lactobacillus paraplantarum, Lactobacillus brevis, Bifidobacterium infantis, Lacticaseibacillus paracasei, or combinations thereof. The one or more bacterial strains can be added at 1×10⁵ to 1×10¹⁰ CFU/g to the pre-fermentation food matrix at the beginning of fermentation, after fermentation has started, or at the end of fermentation. The aryl-lactates can be stable for at least 4 to 6 weeks after the end of fermentation. The pre-fermentation food matrix can be a dairy product, vegetables, beans, grains, fruit, tea, fish, or meat.

Another aspect provides a method of increasing agonist activity for aryl-hydrocarbon receptor (AhR) in a fermented food matrix. The method can comprise adding: (a) alpha-ketoglutarate (AKG), trisodium citrate dehydrate (CIT), or both AKG and CIT; or (b) phenylpyruvic acid (PPyA), 4-hydroxyphenylpyruvic acid (4HPPyA), indole-3-pyruvic acid (IPyA), or combinations thereof; or (c) aromatic amino acids (ArAA) such as phenylalanine (Phe), Tyrosine (Tyr), Tryptophan (Trp), or combinations thereof; or (d) combinations of (a), (b), and (c); to (i) a pre-fermentation food matrix and allowing the pre-fermentation food matrix to ferment to form a fermented food matrix having increased agonist activity for AhR in comparison to a control; or (ii) a pre-fermentation food matrix after the beginning of fermentation and allowing the pre-fermentation food matrix to ferment to form a fermented food matrix having increased agonist activity for AhR in comparison to a control; or (iii) to a fermented food matrix after the end of fermentation to form a fermented food matrix having increased agonist activity for AhR in comparison to a control. The PPyA, 4HPPyA, IPyA, or combinations thereof can each be added at an amount of 0.5-5 mM. The AKG, CIT, or both can each be added at an amount of 0.5-5 mM. The aromatic amino acids (e.g., Phe, Tyr, Trp) or combinations thereof can be added at an amount of about 0.2 to 2.5 mg/mL or about 0.5 to about 10 mM. The method can further comprise adding one or more bacterial strains having aromatic amino transferase (ArAT) activity and/or phenyllactate dehydrogenase (fLDH) activity. The one or more bacterial strains can be Lactiplantibacillus plantarum and/or Bifidobacterium infantis. The one or more bacterial strains can be Lactiplantibacillus plantarum, Lactobacillus rhamnosus, Lactobacillus paraplantarum, Lactobacillus brevis, Bifidobacterium infantis, Lacticaseibacillus paracasei, or combinations thereof. The one or more bacterial strains can be added at 1×10⁵ to 1×10¹⁰ CFU/g the pre-fermentation food matrix at the beginning of fermentation, during fermentation, or at the end of fermentation. The aryl-lactates can be stable for at least 4 to 6 weeks after the start of fermentation. The pre-fermentation food matrix can be a dairy product, vegetables, beans, grains, fruit, tea, fish, or meat.

An aspect provides a method of enhancing the ability of a food matrix to activate an aryl-hydrocarbon receptor (AhR) comprising adding: (a) alpha-ketoglutarate (AKG), trisodium citrate dehydrate (CIT), or both AKG and CIT; or (b) phenylpyruvic acid (PPyA), 4-hydroxyphenylpyruvic acid (4HPPyA), indole-3-pyruvic acid (IPyA), or combinations thereof; (c) aromatic amino acids (ArAA) such as phenylalanine (Phe), Tyrosine (Tyr), Tryptophan (Trp), or combinations thereof; or (d) combinations of (a), (b), and (c); to (i) a pre-fermentation food matrix and allowing the pre-fermentation food matrix to ferment to form a fermented food matrix having enhanced ability to activate AhR in comparison to a control; or (ii) a pre-fermentation food matrix after the beginning of fermentation and allowing the pre-fermentation food matrix to ferment to form a fermented food matrix having enhanced ability to activate AhR in comparison to a control; or (iii) to a fermented food matrix after the end of fermentation to form a fermented food matrix having enhanced ability to activate AhR in comparison to a control. The PPyA, 4HPPyA, IPyA, or combinations thereof can each be added at an amount of 0.5-5 mM. The AKG, CIT, or both can each be added at an amount of 0.5-5 mM. The aromatic amino acids (e.g., Phe, Tyr, Trp) or combinations thereof can be added at an amount of about 0.2 to 2.5 mg/mL or about 0.5 to 10 mM. The method can further comprise adding one or more bacterial strains having aromatic amino transferase (ArAT) activity and/or phenyllactate dehydrogenase (fLDH) activity. The one or more bacterial strains can be Lactiplantibacillus plantarum and/or Bifidobacterium infantis. The one or more bacterial strains can be Lactiplantibacillus plantarum, Lactobacillus rhamnosus, Lactobacillus paraplantarum, Lactobacillus brevis, Bifidobacterium infantis, Lacticaseibacillus paracasei, or combinations thereof. The one or more bacterial strains can be added at 1×10⁵ to 1×10¹⁰ CFU/g the pre-fermentation food matrix at the beginning of fermentation, during fermentation, or at the end of fermentation. The aryl-lactates can be stable for at least 4 to 6 weeks after the start of fermentation. The pre-fermentation food matrix can be a dairy product, vegetables, beans, grains, fruit, tea, fish, or meat.

An aspect provides a fermented food product produced by adding (a) alpha-ketoglutarate (AKG), trisodium citrate dehydrate (CIT), or both AKG and CIT; or (b) phenylpyruvic acid (PPyA), 4-hydroxyphenylpyruvic acid (4HPPyA), indole-3-pyruvic acid (IPyA), or combinations thereof; (c) aromatic amino acids (ArAA) such asphenylalanine (Phe), Tyrosine (Tyr), Tryptophan (Trp), or combinations thereof; or (d) combinations of (a), (b), and (c); to (i) a pre-fermentation food matrix before or during fermentation and allowing the pre-fermentation food matrix to ferment to form a fermented food product; or (ii) a fermented food matrix to form a fermented food product. The aryl-lactates can comprise PLA, 4-HPLA, ILA, or combinations thereof. The PPyA, 4HPPyA, IPyA, or combinations thereof can each be added at an amount of 0.5-5 mM. The AKG, CIT, or both can each be added at an amount of 0.5-5 mM. The aromatic amino acids (Phe, Tyr, Trp) or combinations thereof can be added at an amount of about 0.2 to 2.5 mg/mL or about 0.5 to 10 mM. One or more bacterial strains having aromatic amino transferase (ArAT) activity and/or phenyllactate dehydrogenase (fLDH) activity can also be added to the pre-fermentation food matrix. The one or more bacterial strains can be Lactiplantibacillus plantarum and/or Bifidobacterium infantis. The one or more bacterial strains can be Lactiplantibacillus plantarum, Lactobacillus rhamnosus, Lactobacillus paraplantarum, Lactobacillus brevis, Bifidobacterium infantis, Lacticaseibacillus paracasei, or combinations thereof. The one or more bacterial strains can be added at 1×10⁵ to 1×10¹⁰ CFU/g the pre-fermentation food matrix at the beginning of fermentation, during fermentation, or at the end of fermentation. The pre-fermentation food matrix can be a dairy product, vegetables, beans, grains, fruit, tea, fish, or meat.

An aspect provides a method of inducing weight loss, reducing fat mass, and/or reducing glucose intolerance in an overweight or obese mammal comprising feeding 200 g or more of the fermented food product described herein to the overweight or obese mammal daily for a period of a month or more.

An aspect provides method of inducing weight loss, reducing fat mass, and/or reducing glucose intolerance in an overweight or obese mammal comprising orally administering 400 ng/day to 1 g/day of PLA, 4-HPLA, ILA, or combinations thereof to the overweight or obese mammal.

An aspect provides a pre-fermentation food matrix comprising a food matrix and added (a) alpha-ketoglutarate (AKG), trisodium citrate dehydrate (CIT), or both AKG and CIT; or (b) added phenylpyruvic acid (PPyA), 4-hydroxyphenylpyruvic acid (4HPPyA), indole-3-pyruvic acid (IPyA), or combinations thereof; (c) added aromatic amino acids (ArAA) such as phenylalanine (Phe), Tyrosine (Tyr), Tryptophan (Trp), or combinations thereof; or (d) combinations of (a), (b), and (c). The aryl-lactates can comprise phenyllactic acid (PLA), 4-hydroxyphenyllactic acid (4-HPLA), indole-lactic acid (ILA), or combinations thereof. The PPyA, 4HPPyA, IPyA, or combinations can each be added at an amount of 0.5-5 mM. The AKG, CIT, or both can each be added at an amount of 0.5-5 mM. The aromatic amino acids (e.g., Phe, Tyr, Trp) or combinations thereof can be added at an amount of about 0.2 to 2.5 mg/mL or about 0.5 to 10 mM. The pre-fermentation food matrix can further comprise one or more added bacterial strains having aromatic amino transferase (ArAT) activity and/or phenyllactate dehydrogenase (fLDH) activity. The one or more bacterial strains can be Lactiplantibacillus plantarum and/or Bifidobacterium infantis. The one or more bacterial strains can be Lactiplantibacillus plantarum, Lactobacillus rhamnosus, Lactobacillus paraplantarum, Lactobacillus brevis, Bifidobacterium infantis, Lacticaseibacillus paracasei, or combinations thereof. The one or more bacterial strains can be added at 1×10⁵ to 1×10¹⁰ CFU/g to the pre-fermentation food matrix at the beginning of fermentation, during fermentation, or at the end of fermentation. The pre-fermentation food matrix can be a dairy product, vegetables, beans, grains, fruit, tea, fish, or meat. The term “added” when discussing the pre-fermentation food matrix means that these components are added to the matrix by a human. Generally, these added components are added to the matrix in a purified or isolated form.

An aspect provides a kit comprising: (a) alpha-ketoglutarate (AKG), trisodium citrate dehydrate (CIT), or both AKG and CIT; or (b) phenylpyruvic acid (PPyA), 4-hydroxyphenylpyruvic acid (4HPPyA), indole-3-pyruvic acid (IPyA), or combinations thereof; (c) aromatic amino acids (ArAA) such as phenylalanine (Phe), Tyrosine (Tyr), Tryptophan (Trp), or combinations thereof; or (d)combinations of (a), (b), and (c); and one or more bacterial strains having aromatic amino transferase (ArAT) activity and/or phenyllactate dehydrogenase (fLDH) activity. The one or more bacterial strains can be Lactiplantibacillus plantarum and/or Bifidobacterium infantis. The one or more bacterial strains can be Lactiplantibacillus plantarum, Lactobacillus rhamnosus, Lactobacillus paraplantarum, Lactobacillus brevis, Bifidobacterium infantis, Lacticaseibacillus paracasei, or combinations thereof.

### BRIEF DESCRIPTION OF THE DRAWINGS

FIG. 1a-g. Fermented foods are a source of microbial-derived aryl-lactates. (a) Commercially available foods were homogenized to elute metabolites in a stomacher for 60 s, syringe filtered, and analyzed via LC/MS/MS metabolomics using aryl-lactate standards. (b) total aryl-lactates (PLA+4HPLA+ILA) (c) Phenyllactic acid (PLA), (d) 4-hydroxyphenyllactic acid (4-HPLA), and (e) indole-3-lactic acid (ILA) concentrations are shown in μg/mL. Foods are ordered by descending total aryl-lactate concentration within fermented food categories (dairy, vegetable, miscellaneous) with fermented food type showed, B-E,G have all foods in the same order. (f) Commercially available fermented foods separated and combined according to type of ferment (fermented dairy products, left; fermented vegetables, middle; miscellaneous ferments, right). Total aryl-lactates is the sum of PLA, 4HPLA, and ILA for each fermented food. Statistics using 1-way ANOVA showing comparison between dairy and vegetable ferments total aryl-lactates, PLA, and 4HPLA ***p<0.001. (g) Total aryl-lactates (PLA+4HPLA+ILA) per serving of commercially available fermented foods. One serving is considered 237 mL (8 oz) kefir and kombucha, 177 mL (6 oz) yogurt, 59 mL (¼ c) vegetable ferments, 15 mL (1 Tbsp) fish sauce, and 10 mL (2 tsp) miso paste. Statistics using unpaired T-test comparing average aryl-lactates in 1 serving vegetable vs. dairy ferments **p<0.01. All data displayed as mean+/−SEM.

FIG. 2a-e. Select lactic acid bacteria (LAB) found in commercially available fermented foods produce aryl-lactate metabolites in monoculture. (a) Supernatant from bacteria monoculture were syringe filtered and analyzed via LC/MS/MS targeted metabolomics using aryl-lactate analytical standards. (b) Total aryl-lactates, (c) Phenyllactic acid (PLA), (d) 4-hydroxyphenyllactic acid (4-HPLA), and (e) Indole-3-lactic acid (ILA) concentrations (μg/mL) in select lactic acid bacteria monocultures analyzed via LC/MS. All strains ordered from greatest to least concentration of total aryl-lactates. 7 Lactiplantibacillus plantarum (L. plantarum) strains (left) and additional LAB strains (right, L. rhamnosus, Leuconostoc mesenteroides, Leuconostoc citreum, L. bulgaricus, Lactococcus lactis, L. paraplantarum, an additional L. bulgaricus strain, L. acidophilus, Bifidobacterium infantis, L. casei, L. paracasei, L. reuteri, and L. brevis). Statistical analysis performed using 1-way ANOVA with Dunnett's multiple comparison's test with each L. plantarum strain compared to additional LAB strains. Only significant values for all additional LAB strains shown at p<0.05. ****p<0.0001. Data represented in mean+/−SEM.

FIG. 3a-e. Addition of co-metabolites to lactic acid bacteria (LAB) monocultures promotes the production of aryl-lactates (a) Aromatic amino acid (ArAA) microbial metabolism pathway showing aromatic amino acid metabolism via aromatic amino transferase (ArAT) to aryl-pyruvates, then aryl-pyruvates are metabolized via microbial enzyme phenyllactate dehydrogenase (fLDH) to aryl-lactates and more downstream to additional aryl metabolites. (b) Lactiplantibacillus plantarum (L. plantarum) or (c) Bifidobacterium longum spp. infantis (B. infantis) monoculture inoculated with alpha-ketoglutarate (AKG) and/or trisodium citrate dehydrate (CIT) and syringe filtered supernatant analyzed after 24 hr via LC/MS/MS. (d) L. plantarum or (e) B. infantis monoculture inoculated with phenylpyruvic acid (PPyA), 4-hydroxyphenylpyruvic acid (4HPPyA), or indole-3-pyruvic acid (IPyA) for 24 hours prior to LC/MS/MS targeted analysis of syringe filtered supernatant. All data shown as % concentration of aryl-lactates in treatment condition compared to respective monoculture with no additives.

FIG. 4a-e. Aromatic amino acid metabolism is modifiable in a whole-food matrix to promote aryl-lactate production. (a) Yogurt was made by mixing milk powder and sterile water and heat treating the solution for 30 min prior to being cooled to 40° C. and starter culture (Strep. Thermophilus, L. bulgaricus; Chr-Hansen) plus applicable treatment were added before fermenting at 42° C. for 5 hr. All yogurt samples were syringe-filtered before analyzing via LC/MS/MS. (b) Yogurt with standard starter culture was fermented for 5 hr with treatments including added alpha ketoglutarate (AKG) and/or citrate (CIT), aryl-pyruvates (phenylpyruvic acid (PPyA), 4-hydroxyphenylpyruvic acid (HPPyA), indole-3-pyruvic acid (IPyA)) and B. infantis or L. plantarum with and without blend of aryl-pyruvates (pyruvate blend; PPyA+HPPyA+IPyA). Phenyllactic acid (PLA), 4-hydroxyphenyllactic acid (4HPLA), and indole-3-lactic acid (ILA) percent concentration vs. yogurt control (standard starter culture only) is shown. (c) Concentration of total aryl-lactates in yogurt with various treatment groups and at three points over time: immediate post-5 hr fermentation, fermentation and 1 wk cold storage, and fermentation and 4 wk cold storage. Statistical analysis performed using 2-way ANOVA with Dunnett's multiple comparisons test with all treatments compared to yogurt with starter culture only at same timepoint. Only significant values shown at p<0.05. **p<0.01, ***p<0.001, ****p<0.0001 (d) Concentration of aryl-lactates stacked to show ratio of PLA, 4HPLA, and ILA in yogurt across time points in yogurt with L. plantarum and pyruvate blend. Below each time point, percent change relative to yogurt with starter culture only is listed. (e) Percent concentration vs. yogurt with starter culture only of aryl-lactates in yogurt with added L. plantarum and aromatic amino acids (1.56 mg/mL): phenylalanine (Phe), tyrosine (Tyr), and/or tryptophan (Trp). All Data displayed as mean+/−SEM

FIG. 5a-e. Optimized food matrix conditions to favor aryl-lactate production promotes aryl-hydrocarbon receptor (AhR) activity within two whole food matrices and aryl-lactates bind an immunomodulatory G-protein coupled receptor (GPCR). (a) HepG2 AhR reporter cell line activity in response to aryl-lactate metabolites: phenyllactic acid (PLA), 4-hydroxyphenyllactic acid (4HPLA), and indole-3-lactic acid (ILA). Data is relative to PBS (PLA, 4HPLA) or DMSO (ILA) assay control. Statistics using 1-way ANOVA with Kruskal-Wallis post-hoc, only significant (p<0.05) p-values shown. (b) AhR activity in response to 6 commercially sold dairy products (left) and in-house made yogurt with starter culture only (S. Thermophilus, L. bulgaricus) immediately post-5 hr fermentation (IPF), fermentation with 1 wk cold storage, and fermentation with 4 wk cold storage. Statistics using 1-way ANOVA. (c) AhR activity in response to optimized yogurts with various treatments and 3 timepoints: immediate post 5 hr fermentation, 5 hr fermentation with 1 wk cold storage, and 5 hr fermentation with 4 wk cold storage. Treatments include starter culture only, or starter culture with additional L. plantarum/B. infantis, phenylpyruvate (PPyA), hydroxyphenylpyruvate (HPPyA), indole pyruvate (IPyA), and pyruvate blend (PPyA+HPPyA+IPyA) with and without L. plantarum/B. infantis. Statistical significance using 2-way ANOVA with Dunnett's multiple comparisons test with all treatments compared to yogurt with starter culture at same timepoint showed. (d) AhR activity in response to sauerkraut fermentation after 10 d wild ferment with various treatments: wild sauerkraut control, and additions of the following on day 0 of ferment: L. plantarum, PPyA, HPPyA, IPyA, and pyruvate blend with and without L. plantarum. (e) G-protein coupled receptor (GPCR) activation assay (PRESTO-Tango) indicates that phenyllactic acid (PLA) and indole-3-lactic acid (ILA), but not 4-hydroxyphenyllactic acid (4HPLA), bind human-specific hydroxycarboxylic acid receptor 3 (HCAR3). The direct signaling activity of 4HPLA remains unresolved. Statistical significance using 1-way ANOVA comparing all treatments to sauerkraut control as well as sauerkraut control compared to cell assay control. Only significant (p<0.05) p-values shown. *p<0.05, **p<0.01, ***p<0.001, ****p<0.0001. All data displayed as mean+/−SEM.

FIG. 6a-c shows chromatographs of (a) phenyllactic acid (PLA), (b) 4-hydroxyphenyllactic acid (4HPLA), and (c) indole-3-lactic acid (ILA) peaks via LC/MS/MS.

FIG. 7a-h. Commercially available foods were homogenized in a stomacher for 60 s, syringe filtered, and analyzed via LC/MS/MS metabolomics using aryl-lactate standards. (a) total aromatic amino acids (ArAAs; Phe+Tyr+Trp) (b) phenylalanine (Phe), (c) tyrosine (Tyr), and (d) tryptophan (Trp) concentrations are shown in μg/mL. (e) total aryl-acetates (phenylacetate [PAA; not-detected in any food]+4-hydroxyphenylacetate [HPAA]+indoleacetate [IAA]), (f) HPAA, and (g) IAA concentrations in μg/mL. (h) Ratio of total aryl-lactates/total aryl-acetates. Foods are in the same order as FIG. 1B-E,G, with descending total aryl-lactate concentration within the fermented food categories (dairy, vegetable, miscellaneous) with fermented food type showed.

FIG. 8a. Commercially available fermented foods were anaerobically cultured, and isolated DNA was identified via qPCR. A lower cycle threshold (CT) indicating high abundance of the LAB species is shown in black, while a higher CT indicating low abundance or lack of the species is shown in white.

FIG. 9a-f. (a-b) Yogurt with standard starter culture (Strep. Thermophilus, L. bulgaricus; Chr-Hansen) plus applicable treatment were added before fermenting for 5 hr with additional (a) 1 wk cold storage and (b) 4 wk cold storage. Treatments include: added alpha-ketoglutarate (AKG) and/or citrate (CIT), aryl-pyruvates (phenylpyruvic acid (PPyA), 4-hydroxyphenylpyruvic acid (HPPyA), indole-3-pyruvic acid (IPyA)) and B. infantis or L. plantarum with and without blend of aryl-pyruvates (pyruvate blend; PPyA+4HPPyA+IPyA). Phenyllactic acid (PLA), 4-hydroxyphenyllactic acid (4HPLA), and indole-3-lactic acid (ILA) percent concentration vs. yogurt control (standard starter culture only) at same timepoint is shown. (c-d) yogurt immediate post-5 hr fermentation with same treatments as (a-b) quantified for (c) aryl-acetates: phenylacetate (PAA), 4-hydroxyphenylacetate (HPAA), and indole acetate (IAA) μg/mL and (d) aryl-lactates (μg/mL) shown on same axis to compare quantities of each. (e-f) Sauerkraut was made by submerging freshly chopped cabbage in salt brine and fermenting for 10 d. All sauerkraut samples were syringe-filtered before analyzing via LC/MS/MS. Sauerkraut with no additives after a 10 d ferment was compared to the following treatments: (e) PPyA, HPPyA, IPyA, pyruvate blend all with and without added L. plantarum and (f) AKG and/or CIT all with or without added L. plantarum. Data displayed as percent aryl-lactate (PLA, 4HPLA, ILA) concentration in treatment group compared to control sauerkraut. Experiment done in replicates of at least 4.

FIG. 10A-10E. Aryl-lactates were provided in drinking water at concentrations in range (0.25 mg/mL) of total aryl-lactate within our optimized fermented food conditions as described by Kasperek et al. Food Chemistry (2024) 2024 Oct. 1:454:139798. FIG. 10A shows the experimental protocol. FIG. 10B left panel shows body weight (% baseline weight) across aryl-lactate+diet treatment. FIG. 10B right panel shows percent body weight change at D60. FIG. 10C shows percent of mice on the control diet verses the high fat diet. FIG. 10D shows the percent fat mass of mice on the control diet versus the high fat diet as determined by Echo MRI at D56. FIG. 10E shows the oral glucose tolerance test at D60. FIG. 10E right panel shows glucose area under the curve (AUC). *p<0.05.

FIG. 11A-11E. shows imaging with an Echo MRI and tissue collection of mice. Aryl-lactate concentrations were provided in drinking water in combination (to mice at concentrations in range (0.75 mg/mL) of total aryl-lactates (Aryl^{Comb:}PLA+4HPLA+ILA) within our optimized fermented food conditions as described by Kasperek et al. Food Chemistry (2024) 2024 Oct. 1:454:139798. FIG. 11A. shows the experimental protocol FIG. 11B shows percent body weight change at post aryl-lactate+diet treatment FIG. 11C shows body fat (g) at 8 wk. FIG. 11D-E show body fat (%) and lean mass at (%) 8 wk.

### DETAILED DESCRIPTION

Provided herein are methods of robustly increasing aryl-lactates (e.g., phenyllactic acid (PLA), 4-hydroxyphenyllactic acid (4-HPLA) and indolelactic acid (ILA)) in whole fermented food matrices that results in enhanced bioactivity of foods. The methods can comprise supplementing whole fermented food matrices (before or after active fermentation) with novel formulations of 1) microbial aryl-lactate producers (e.g., Lactiplantiballius plantarum and Bifidobacterium infantis) and/or 2) unique blends of co-metabolites and co-factors (e.g., citrate, alpha-ketoglutrate, phenylpyruvic acid, 4-hyrodxyphenylpyruvic acid, indolepyruvic acid, and/or 3) aromatic amino acids). These methods can directly impact the ability of these foods to activate the aryl hydrocarbon receptor (AhR) and hydroxycarboxylic acid receptor 3 (HCAR3).

Microbial aryl-lactate concentrations are inversely associated with chronic inflammation in preclinical models and in humans. PLA and ILA have all shown promise in directly attenuating risk of inflammatory disease (e.g., early onset obesity and cancer). These food optimization strategies can utilized to promote gut and immune health.

The methods described herein can enhance microbial aromatic amino acid metabolism in fermented foods in ways that significantly increased the natural bioactivity of fermented food products. Aryl-hydrocarbon receptor activation by microbial ligands can provide improved gut health and the prevention of chronic inflammation. The compositions and methods can be utilized used to, for example, promote gut and immune health.

Methods for increasing bioactivity of whole food matrices by increasing aromatic amino acid metabolism to aryl-lactates has never been attempted. Moreover, no known work has ever attempted to increase aryl-hydrocarbon receptor activity of fermented food matrices. Methods to maintain the bioactivity (AhR receptor activation) of these fermented foods throughout an extended (4 week) storage period are provided herein. This solves a problem, as tested commercially available fermented foods were highly variable in their ability to activate AhR while unoptimized fermented food conditions (e.g. yogurt fermented with only a standard starter culture—L. bulgaricus and S. thermophilus) exhibited a loss of AhR bioactivity to undetectable levels after 4 weeks of cold storage. This was compared to foods treated with the formulations described herein which can enhance AhR activity up to >3,000× control levels after 4 weeks of storage. The methods and compositions provided herein also solve a problem of applicability since the bioactivity optimization methods are usable across a variety different types of fermented food types (e.g. Vegetable (Sauerkraut) and Dairy (Yogurt)). Bioactivity was also increased in ‘wild-ferments’ such as sauerkraut without the addition of probiotics (e.g. adding only co-factors such as indole pyruvate).

### Fermented Food Matrices

Fermented foods are foods or beverages produced through controlled microbial growth, which causes conversion of food components by enzymatic action.

A pre-fermentation food matrix as used herein is food matrix (e.g., a dairy product (e.g., milk), vegetables, beans, grains, fruit, tea, fish, meat, etc.) prior to fermentation taking place. In an aspect, a pre-fermentation food matrix additionally comprises microorganisms (e.g., yeast or bacteria) naturally in the raw food or processing environment, starter cultures of yeast or bacteria that are added to the matrix, or both naturally occurring microorganisms and starter cultures.

A fermented matrix is a food matrix that has undergone fermentation for at least 1, 2, 3, 4, 5, 6, or more days, or 1, 2, 3, 4, 5, 6, 7, 8, 9, or 10 or more weeks.

A fermented food matrix can be yogurt, bread, cheese, cottage cheese, fish sauce, natto, soybean paste, shrimp paste, soy sauce, tofu, tempeh, miso, kombucha, kefir, pickled vegetable, sauerkraut, salami, prosciutto, quark, creme fraiche, skyr, mead, kimchi, sausage, or any other fermented food.

Food matrices can be fermented naturally, often referred to as “wild ferments” or “spontaneous ferments”, where the microorganisms are present naturally in the raw food or processing environment. In other aspects, foods can be fermented via the addition of starter cultures, known as “culture-dependent ferments.” In some aspects, a combination of wild microorganisms and cultured-dependent ferments are used.

Any fermentation conditions can be used. In one example, yogurt can be made using any type of milk (e.g., soy milk, goat, buffalo, sheep, or cow milk). One or more types of bacteria (e.g., Lactobacillus bulgaricus and Streptococcus thermophilus) can be inoculated into the milk. A fermentation temperature can be from, for example, about 25° to about 48° C. (e.g., 25, 30, 32, 35, 40, or 48° C.) and the fermentation time can be from about 3-72 hours (e.g., about 3, 5, 10, 20, 30, 40, 50, 60, 70 or more hours). In an aspect, the fermentation ends with a relatively stable pH value. The pH value at the end of the fermentation can be from, e.g. pH 3.2 to 6.2 (e.g., about 3.2, 4.0, 5.0, 6.0 or more).

A vegetable fermentation can be made without inoculating the fermentation food matrix with a starter culture. For example, sauerkraut can be made be cutting up cabbage and salting the cabbage. The cabbage can be packed into a container and placed in a cool, well-ventilated area at about 20-23° C. for about 3-14 days.

Fermentation techniques for other fermentation food matrices are known to those of skill in the art.

### Aryl Pyruvates

In an aspect, aryl pyruvates including phenylpyruvic acid (PPyA), 4-hydroxyphenylpyruvic acid (4HPPyA), indole-3-pyruvic acid (IPyA) can be added to a pre-fermentation food matrix or a fermented food matrix at an amount of about 0.5, 1.0, 1.5, 2.0, 2.5, 3.0, 3.5, 4.0, 4.5, 5.0 mM or more (or any range between about 0.5 nd 5.0 mM).

### AKG and CIT

In an aspect, alpha-ketoglutarate (AKG) and/or trisodium citrate dehydrate (CIT) can be added to a pre-fermentation food matrix or a fermented food matrix at an amount of about 0.5, 1.0, 1.5, 2.0, 2.5, 3.0, 3.5, 4.0, 4.5, 5.0 mM or more (or any range between about 0.5 and 5.0 mM).

### Aromatic Amino Acids

In an aspect, aromatic amino acids, including phenylalanine (Phe), tyrosine (Tyr), and/or tryptophan (Trp) can each be added to a pre-fermentation matrix or a fermented food matrix in an amount of about 0.5, 1.0, 2.0, 3.0, 4.0, 5.0, 6.0, 7.0, 8.0, 9.0, 10.0, 11.0, 12.0, 13.0, 14.0, 15.0 mM or more (or any range between about 0.5 and 15 mM). In an aspect, aromatic amino acids such as Phe, Tyr, and/or Trp can be added to a pre-fermentation matrix or a fermented food matrix in an amount of about 0.2, 0.3, 0.4, 0.5, 0.7, 0.8, 0.9, 1.0, 1.25, 1.5, 1.56, 1.75, 2.0, 2.25, 2.5 (or any range between about 0.2 and 2.5 mg/mL).

### Aryl Lactates

In an aspect, aryl-lactates are increased in a fermented food matrix as compared to a fermented food matrix not subjected to the methods described herein. Aryl-lactates include phenyllactic acid (PLA), 4-hydroxyphenyllactic acid (4-HPLA), indole-lactic acid (ILA), or combinations thereof.

The amount of aryl-lactates in a fermented food matrix can be measured via, for example, LC/MS/MS targeted metabolomics. See, e.g., Example 2. In an aspect, the amount of one or more aryl-lactates can be increased in the fermented food matrix by 5, 10, 50, 100, 250, 500, 750, 1,000, 2,000, 3,000, 4,000, 5,000, 6,000, 7,000, 8,000, 9,000 fold or more as compared to control fermented food matrices that are not treated according to the methods described herein. In an aspect, after treatment, the amount of aryl-lactates in a fermented food matrix can be about 30, 50, 75, 100, 125, 150, 175, 200, 300 μg/mL or more.

Bacteria with Aromatic Amino Transferase (ArAT) Activity and/or Phenyllactate Dehydrogenase (fLDH) Activity

In an aspect, one or more bacterial strains having aromatic amino transferase activity and/or phenyllactate dehydrogenase (fLDH) activity, that is having one or more genes encoding aromatic aminotransferase (ArAT) enzymes and/or phenyllactate dehydrogenase (fLDH) enzymes, can be added to a pre-fermentation food matrix or a fermented food matrix. ArAT or fLDH enzymes can naturally be expressed by the bacteria. Alternatively, bacteria can be genetically engineered to produce one or more ArAT enzymes and/or one or more fLDH enzymes. Aromatic amino transferase activity means that the bacteria can catalyze transamination, a reaction that moves an amino group from an amino acid to a keto acid. Phenyllactate dehydrogenase activity means the bacteria can catalyze the reduction of phenylpyruvic acid (PPA) to phenyllactic acid.

Examples of bacteria having aromatic amino transferase activity and/or phenyllactate dehydrogenase (fLDH) activity are Lactiplantibacillus plantarum, Lactobacillus rhamnosus, Lactobacillus paraplantarum, Lactobacillus brevis, Bifidobacterium infantis, Lacticaseibacillus paracasei, or combinations thereof. Examples of amino acid sequences of ArAT enzymes include GenBank Accession numbers BBA82750.1; BBA80870.1; VTU69952.1; PCL43410.1; ERL43216.1; KRK21792.1; KIN21457.1; BBF75082.1; and BBF73782.1.

fLDH catalyzes the reduction of phenylpyruvic acid (PPA) to phenyllactic acid (PLA). Examples of bacteria having fLDH activity are Lactiplantibacillus plantarum, Lactobacillus rhamnosus, Lactobacillus paraplantarum, Lactobacillus brevis, Bifidobacterium infantis, Lacticaseibacillus paracasei, or combinations thereof. Examples of amino acid sequences of fLDH enzymes include GenBank Accession numbers SPE19666.1, WP_089556583.1, AQR54986.1, XBU37529.1, TEA96251.1, TEA88785.1, and KAB7790021.1

In an aspect, bacteria are added to a pre-fermentation food matrix or a fermented food matrix at about 10⁴ to 10¹⁵ colony forming units/g (CFU/g) (e.g., about 10⁴, 10⁵, 10⁶, 10⁷, 10⁸, 10⁹, 10¹⁰, 10¹¹, 10¹², 10¹³, 10¹⁴, or 10¹⁵, or any range between about 10⁴ to 10¹⁵ CFU/g.

One or more bacterial strains (e.g., recombinant or naturally-occurring bacterial strains having aromatic amino transferase activity and/or phenyllactate dehydrogenase (fLDH) activity) can be added at 1×10⁵ to 1×10¹⁰ CFU/g simultaneously with a starter culture in a fermentation food matrix, at the beginning of fermentation (with or without a starter culture) (e.g., at day 0, 1, 2, 3, or 4 of the fermentation), during fermentation, or can be added at the end of fermentation.

The bacteria can be in a concentrated form including frozen, dried, or freeze-dried concentrates.

### Method of Increasing Aryl-Lactates

Methods of increasing aryl-lactates in a fermented food matrix (e.g., dairy product, vegetables, beans, grains, fruit, tea, fish, or meat) are provided. The methods can comprising adding: (a) alpha-ketoglutarate (AKG), trisodium citrate dehydrate (CIT), or both AKG and CIT; or (b) phenylpyruvic acid (PPyA), 4-hydroxyphenylpyruvic acid (4HPPyA), indole-3-pyruvic acid (IPyA), or combinations thereof; (c) aromatic amino acids (e.g., phenylalanine (Phe), tyrosine (Tyr), tryptophan (Trp), or combinations thereof); or (d) combinations of (a), (b), and (c) to a pre-fermentation food matrix and allowing the pre-fermentation food matrix to ferment to form a fermented food matrix having increased amounts of aryl-lactates in comparison to a control. In some aspects, the AKG, CIT, PPyA, 4HPPyA, and/or IPyA can be added after the start of the fermentation (e.g., about 1, 4, 8, 12, 24, 36, 48, 72 hours or more) after the start of fermentation. In some aspects, the AKG, CIT, PPyA, 4HPPyA, and/or IPyA can be added after the end of the fermentation (e.g., about 1, 4, 8, 12, 24, 36, 48, 72 hours or more after the end of the fermentation). The end of a fermentation can be about 1, 2, 3, 4, 5, 6, or more days, or 1, 2, 3, 4, 5, 6, 7, 8, 9, or 10 or more weeks after the start of fermentation, or when the fermented food matrix is transferred to refrigeration temperatures (about 3.5, 4.0, 4.4, or 4.8° C.), when the pH stabilizes, or when the user determines the desired level of fermentation has been reached. The aryl-lactates can comprise phenyllactic acid (PLA), 4-hydroxyphenyllactic acid (4-HPLA), indole-lactic acid (ILA), or combinations thereof.

In an aspect, AKG, CIT, or both AKG and CIT are used.

In an aspect, PPyA, 4HPPyA, IPyA, or combinations thereof are used.

In an aspect, Phe, Tyr, Trp, or combinations thereof are used.

In an aspect, AKG, CIT, or both AKG and CIT; PPyA, 4HPPyA, IPyA, or combinations thereof; and Phe, Tyr, Trp, or combinations thereof are used.

In an aspect, PPyA, 4HPPyA, IPyA, or combinations thereof and Phe, Tyr, Trp, or combinations thereof are used.

In an aspect, AKG, CIT, or both AKG and CIT and Phe, Tyr, Trp, or combinations thereof are used.

In an aspect, PPyA, 4HPPyA, IPyA, or combinations thereof and Phe, Tyr, Trp, or combinations thereof are used.

The PPyA, 4HPPyA, IPyA, or combinations thereof can be added at an amount of about 0.5, 1.0, 1.5, 2.0, 2.5, 3.0, 3.5, 4.0, 4.5, 5.0 mM or more. The AKG, CIT, or both can be added at an amount of about 0.5, 1.0, 1.5, 2.0, 2.5, 3.0, 3.5, 4.0, 4.5, 5.0 mM or more. The aromatic amino acids (e.g., Phe, Tyr, Trp, or combinations thereof) can be added at an amount of about 0.5-10 mM or more or about 0.2 to 2.5 mg/mL.

Additionally, one or more naturally occurring or genetically engineered bacteria having aromatic amino transferase (ArAT) and/or phenyllactate dehydrogenase (fLDH) activity can be added to the pre-fermentation food matrix at the beginning of fermentation, during fermentation, or at the end of fermentation.

In some aspects, the bacteria having ArAT and/or fLDH activity can be added after the start of the fermentation (e.g., about 1, 4, 8, 12, 24, 36, 48, 72 hours or more) after the start of fermentation. In some aspects, the bacteria having ArAT and/or fLDH activity can be added after the end of the fermentation (e.g., about 1, 4, 8, 12, 24, 36, 48, 72 hours or more after the end of the fermentation). The one or more bacterial strains can be, for example, Lactiplantibacillus plantarum, Lactobacillus rhamnosus, Lactobacillus paraplantarum, Lactobacillus brevis, Bifidobacterium infantis, Lacticaseibacillus paracasei, or combinations thereof.

In some aspects, the (a) alpha-ketoglutarate (AKG), trisodium citrate dehydrate (CIT), or both AKG and CIT; or (b) phenylpyruvic acid (PPyA), 4-hydroxyphenylpyruvic acid (4HPPyA), indole-3-pyruvic acid (IPyA), or combinations thereof; (c) aromatic amino acids (e.g., phenylalanine (Phe), tyrosine (Tyr), tryptophan (Trp), or combinations thereof); or (d) combinations of (a), (b), and (c) and/or the bacteria can be added at the end of fermentation and then the fermented food matrix can be stored at, for example, refrigeration temperatures.

In an aspect, the aryl-lactates in a fermented food matrix prepared by any of the methods described herein are stable upon storage for 1, 2, 3, 4, 5, 6 weeks or more or 1, 2, 3 or more months.

In an aspect, one or more aryl-lactates (e.g., PLA, 4-HPLA, and/or ILA) are increased in a fermented food matrix as compared to a fermented food matrix not treated by the methods described herein (e.g., addition of one or more aryl pyruvates, AKG, CIT, and/or bacteria with ArAT and/or fLDH activity). The increase can be about 10, 20, 30, 40, 50, 75, 100, 150, 200, 300, 400, 500, 750, 1,000% or more as compared to control fermented food matrices not treated by the methods described herein.

### Increasing Agonist Activity for Human Aryl-Hydrocarbon Receptor (AhR)

In an aspect, a method of increasing agonist activity for human aryl-hydrocarbon receptor (AhR) in a fermented food matrix (e.g., dairy product, vegetables, beans, grains, fruit, tea, fish, meat, etc.) is provided. The method comprises adding: (a) alpha-ketoglutarate (AKG), trisodium citrate dehydrate (CIT), or both AKG and CIT; or (b) phenylpyruvic acid (PPyA), 4-hydroxyphenylpyruvic acid (4HPPyA), indole-3-pyruvic acid (IPyA), or combinations thereof; or (c) aromatic amino acids (e.g., phenylalanine (Phe), tyrosine (Tyr), tryptophan (Trp), or combinations thereof); or (d) combinations of (a), (b), and (c); to a pre-fermentation food matrix and allowing the pre-fermentation food matrix to ferment to form a fermented food matrix having increased agonist activity for human AhR. In some aspects, the AKG, CIT, PPyA, 4HPPyA, IPyA and/or Phe, Tyr, Trp or combinations thereof can be added after the start of the fermentation (e.g., about 1, 4, 8, 12, 24, 36, 48, 72 hours or more) after the start of fermentation. In some aspects, the AKG, CIT, PPyA, 4HPPyA, r IPyA, Phe, Tyr, Trp and/or combinations thereof can be added after the end of the fermentation (e.g., about 1, 4, 8, 12, 24, 36, 48, 72 hours or more after the end of the fermentation).

Another aspect provides a method of enhancing the ability of a food matrix to activate the human aryl-hydrocarbon receptor (AhR). The method comprises adding: (a) alpha-ketoglutarate (AKG), trisodium citrate dehydrate (CIT), or both AKG and CIT; or (b) phenylpyruvic acid (PPyA), 4-hydroxyphenylpyruvic acid (4HPPyA), indole-3-pyruvic acid (IPyA), or combinations thereof; or (c) both (a) and (b); to a pre-fermentation food matrix and allowing the pre-fermentation food matrix to ferment to form a fermented food matrix with enhanced ability of a food matrix to activate the human aryl-hydrocarbon receptor (AhR). In some aspects, the AKG, CIT, PPyA, 4HPPyA, and/or IPyA can be added after the start of the fermentation (e.g., about 1, 4, 8, 12, 24, 36, 48, 72 hours or more) after the start of fermentation. In some aspects, the AKG, CIT, PPyA, 4HPPyA, and/or IPyA can be added after the end of the fermentation (e.g., about 1, 4, 8, 12, 24, 36, 48, 72 hours or more after the end of the fermentation).

Additionally, one or more naturally occurring or genetically engineered bacteria having aromatic amino transferase (ArAT) and/or phenyllactate dehydrogenase (fLDH) activity can be added to the pre-fermentation food matrix at the beginning of fermentation, during fermentation, or at the end of fermentation. In some aspects, the bacteria having ArAT and/or fLDH activity can be added after the start of the fermentation (e.g., about 1, 4, 8, 12, 24, 36, 48, 72 hours or more) after the start of fermentation. In some aspects, the bacteria having ArAT and/or fLDH activity can be added after the end of the fermentation (e.g., about 1, 4, 8, 12, 24, 36, 48, 72 hours or more after the end of the fermentation).

In an aspect, agonist activity for AhR or activation of AhR can be measured via an ex vivo AhR reporter cell line (HepG2 Lucia, Invivogen), see Example 3. AhR activity can be increased 2, 3, 4, 5, 6, 7, 8, 10 fold or more as compared to control cells not exposed to PPyA, 4HPPyA, or IPyA and/or bacteria having ArAT activity.

In an aspect, fLDH activity can be measured by monitoring the decrease in absorbance at 340 nm due to the oxidation of NADH (nicotinamide adenine dinucleotide) in a reaction mixture containing the enzyme, phenylpyruvate, and NADH.

The PPyA, 4HPPyA, IPyA, or combinations thereof can be added at an amount of about or combinations are added at an amount of about 0.5, 1.0, 1.5, 2.0, 2.5, 3.0, 3.5, 4.0, 4.5, 5.0 mM or more. The AKG, CIT, or both can be added at an amount of about 0.5, 1.0, 1.5, 2.0, 2.5, 3.0, 3.5, 4.0, 4.5, 5.0 mM or more. The aromatic amino acids (e.g., Phe, Tyr, Trp, or combinations thereof) can be added at an amount of about 0.5-10 mM or more or about 0.2 to 2.5 mg/mL In an aspect, the aryl-lactates in a fermented food matrix are stable upon storage for 1, 2, 3, 4, 5, 6 weeks or more or 1, 2, 3 or more months.

### Overweight and Obesity

Overweight is a condition of excessive fat deposits, while obesity is a chronic disease defined by excessive fat deposits that can impair health. Obesity can lead to increased risk of type 2 diabetes, cancers, and heart disease and can affect bone health and reproduction.

The diagnosis of overweight and obesity is made in humans by measuring weight and height and calculating the body mass index (BMI): weight (kg)/height² (m²). BMI is a surrogate marker of fatness and additional measurements, such as the waist circumference, can help the diagnosis of obesity.

BMI categories for defining obesity are broken down by age. In adults, the World Health Organization defines overweight as a BMI greater than or equal to 25; and obesity is a BMI greater than or equal to 30.

In an aspect, a method of inducing weight loss, reducing fat mass, and/or reducing glucose intolerance in an overweight or obese mammal is provided. Weight loss means that mammal loses about 1, 5, 10, 20, 25, 30% or more of their total body weight over a period of about 1, 2, 3, 4, or more weeks or 1, 2, 3, 4, 5, 6, or more months. Reducing fat mass means the overweight or obese mammal loses about 1, 5, 10, 20, 25, 30% or more of their fat mass over a treatment period of about 1, 2, 3, 4, or more weeks or 1, 2, 3, 4, 5, 6, or more months. Fat mass can be determined by, for example, BMI calculation, skinfold calipers, bioelectrical impedance analysis, dual-energy X-ray absorptiometry, echo MRI, or any other suitable method.

Glucose intolerance can be measured by having the test subject drink a glucose solution and then at one or more time intervals (e.g., 1 hour after drinking, 2 hours after drinking, 3 hours after drinking) blood samples are taken and the blood sugar levels are measured. In humans, a healthy blood glucose level is lower than 140 mg/dL. A blood glucose level between 140 and 199 mg/dL is considered pre-diabetic, and a blood glucose level of 200 mg/dL or more is considered diabetic. In an aspect, an obese or overweight mammal treated by the methods described herein will have a lower blood glucose level in an oral glucose intolerance test than an obese or overweight mammal that was not treated according the methods described herein. In an aspect, a blood glucose level is decreased by 5, 10, 20, 30, 40, 50 mg/dL or more.

In an aspect, weight loss is induced, fat mass is reduced, and/or glucose intolerance is reduced in an overweight or obese mammal by feeding about 150, 200, 250, 300, 400, 500, 600 or more grams of a fermented food product/day as described herein. These numbers are based on an overweight or obese human. The amounts can be adjusted for other mammals. In an aspect, the fermented food product is delivered 1, 2, 3, 4, or more times a day for a treatment period. In an aspect, the food product is delivered 1, 2, 3, 4, or more times every other day for a treatment period.

In an aspect, weight loss is induced, fat mass is reduced, and/or glucose intolerance is reduced in an overweight or obese mammal by orally administering about 350, 400, 500, 600, 700 or more ng/day of PLA, 4-HPLA, ILA, or combinations thereof to the overweight or obese mammal. In an aspect, about 0.001, 0.01, 0.1, 1.0 g/day can be administered to the overweight or obese animal. These numbers are based on an overweight or obese human. The amounts can be adjusted for other mammals. In an aspect, the PLA, 4-HPLA, ILA, or combinations thereof is delivered 1, 2, 3, 4, or more times a day for a treatment period. In an aspect, the PLA, 4-HPLA, ILA, or combinations thereof is delivered 1, 2, 3, 4, or more times every other day for a treatment period.

In some aspects, feeding the fermented food matrices described herein or the aryl lactates described herein can limit high fat diet induced: 1) weight gain (e.g., using 4HPLA) 2) body composition deficits (e.g., using 4HPLA and ILA) and 3) glucose intolerance (e.g., using 4HPLA). These effects can be obtained in an overweight, obese, or normal weight mammal.

### Kits

An aspect provides kits for the preparation of fermented food matrices with increased amounts of aryl-lactates as compared with control fermented food matrices. A kit can comprise, for example,
(a) alpha-ketoglutarate (AKG), trisodium citrate dehydrate (CIT), or both AKG and CIT;
(b) phenylpyruvic acid (PPyA), 4-hydroxyphenylpyruvic acid (4HPPyA), indole-3-pyruvic acid (IPyA), or combinations thereof;
(c) aromatic amino acids (e.g., phenylalanine (Phe), tyrosine (Tyr), tryptophan (Trp), or combinations thereof); or
(d) combinations of (a), (b), and (c); and, optionally one or more bacterial strains having aromatic amino transferase (ArAT) activity and/or phenyllactate dehydrogenase (fLDH) activity.

AKG can be present in an amount of about 5, 10, 50, 100, 1000 g or more or 1, 5, 10, 50 Kg or more. CIT can be present in an amount of about 5, 10, 50, 100, 1000 g or more or 1, 5, 10, 50 Kg or more. PPyA, 4HPPyA, and IPyA can be present in an amount of about 5, 10, 50, 100, 1000 g or more or 1, 5, 10, 50 Kg or more. Aromatic amino acids, (e.g., Phe, Tyr, and/or Trp) can be present in an amount of 5, 10, 50, 100, 1000 g or more or 1, 5, 10, 50 Kg or more. Each bacterial strain can be present in an amount of about 5, 10, 50, 100, 1000 g or more or 1, 5, 10, 50 Kg or more of 1×10⁵ to 1×10¹⁰ or more CFU/g.

The compositions and methods are more particularly described below and the Examples set forth herein are intended as illustrative only, as numerous modifications and variations therein will be apparent to those skilled in the art. The terms used in the specification generally have their ordinary meanings in the art, within the context of the compositions and methods described herein, and in the specific context where each term is used. Some terms have been more specifically defined herein to provide additional guidance to the practitioner regarding the description of the compositions and methods.

As used herein, the term “and/or” includes any and all combinations of one or more of the associated listed items. As used in the description herein and throughout the claims that follow, the meaning of “a”, “an”, and “the” includes plural reference as well as the singular reference unless the context clearly dictates otherwise. The term “about” in association with a numerical value means that the value varies up or down by 5%. For example, for a value of about 100, means 95 to 105 (or any value between 95 and 105).

All patents, patent applications, and other scientific or technical writings referred to anywhere herein are incorporated by reference herein in their entirety. The aspects illustratively described herein suitably can be practiced in the absence of any element or elements, limitation or limitations that are specifically or not specifically disclosed herein. Thus, for example, in each instance herein any of the terms “comprising,” “consisting essentially of,” and “consisting of” can be replaced with either of the other two terms, while retaining their ordinary meanings. The terms and expressions which have been employed are used as terms of description and not of limitation, and there is no intention that in the use of such terms and expressions of excluding any equivalents of the features shown and described or portions thereof, but it is recognized that various modifications are possible within the scope of the claims. Thus, it should be understood that although the present methods and compositions have been specifically disclosed by aspects and optional features, modifications and variations of the concepts herein disclosed can be resorted to by those skilled in the art, and that such modifications and variations are considered to be within the scope of the compositions and methods as defined by the description and the appended claims.

Any single term, single element, single phrase, group of terms, group of phrases, or group of elements described herein can each be specifically excluded from the claims.

Whenever a range is given in the specification, for example, a temperature range, a time range, a composition, or concentration range, all intermediate ranges and subranges, as well as all individual values included in the ranges given are intended to be included in the disclosure. It will be understood that any subranges or individual values in a range or subrange that are included in the description herein can be excluded from the aspects herein. It will be understood that any elements or steps that are included in the description herein can be excluded from the claimed compositions or methods.

In addition, where features or aspects of the compositions and methods are described in terms of Markush groups or other grouping of alternatives, those skilled in the art will recognize that the compositions and methods are also thereby described in terms of any individual member or subgroup of members of the Markush group or other group.

The following are provided for exemplification purposes only and are not intended to limit the scope of the aspects described in broad terms above.

### EXAMPLES

### Example 1 Materials and Methods

### Food Homogenization and Metabolomics Preparation

Commercially available fermented foods including kefir, yogurts, cottage cheese, sauerkraut, kimchi, pickles, fermented beets and carrots, kombucha, salami, fish sauce, and miso paste were collected from a local grocery store (brands and product descriptions listed in key resources Table 1). All foods were diluted 1:10 with PBS and placed in a stomacher (Seward™ Stomacher™ Model 80 Biomaster Blender 110V) for 60 seconds on high and homogenized liquid was syringe filtered (0.22-micron) before downstream LC/MS/MS metabolomics analysis.

Key Resources Table 1

| Fermented Food Product | Brand & Product Description |
|---|---|
| Kefir | Lifeway Kefir - 1%, plain |
| Kefir | Lifeway Kefir - 1%, strawberry |
| Yogurt | Chobani - Greek, nonfat, plain |
| Kefir | Lifeway Kefir - 3.25%, plain |
| Yogurt | Siggi - nonfat, plain |
| Yogurt | Oatly! - plain |
| Yogurt | Yoplait - Greek, nonfat, vanilla |
| Yogurt | Siggi - whole fat, strawberry, drinkable |
| Yogurt | Yoplait - low fat, vanilla |
| Yogurt | Fage - nonfat, plain |
| Kefir | Zymosi - whole fat, passion fruit |
| Cottage Cheese | GoodCulture - whole fat |
| Cottage Cheese | Daisy - 4% |
| Yogurt | Fage - 5%, plain |
| Fermented Carrots | Zymbiotics - Ginger Zarrots |
| Sauerkraut | Claussen |
| Sauerkraut | PATCH |
| Kimchi | Wildbrine - kimchi with miso and horseradish |
| Kimchi | Zymbiotics |
| Fermented Beets | Zymbiotics |
| Sauerkraut | Bubbies |
| Sauerkraut | Zymbiotics |
| Pickles | Bubbies |
| Kimchi | Sunja's - medium spicy |
| Salami | Columbus - Italian Dry Salame |
| Fish Sauce | Red Boat |
| Kombucha | Synergy - Original |
| Miso | Miso Master - Organic Mellow White Miso |
| Bacteria | Strain (if known) All strains from Miller |
| Lactobacillus plantarum | MJM548 |
| Lactobacillus plantarum | MJM547 |
| Lactobacillus plantarum | MJM550 |
| Lactobacillus plantarum | MJM549 |
| Lactobacillus plantarum | ATCC 14917 |
| Lactobacillus plantarum | Cargill - LP-66 |
| Lactobacillus plantarum | ATCC 8014 |
| Lactobacillus rhamnosus | ATCC 53103 |
| Leuconostoc mesenteroides subsp. | ATCC 8293 |
| Leucosonostoc citreum | EFEL2700 |
| Lactobacillus delbrueckii subsp. bulgaricus | ATCC 11842 |
| Lactococcus lactis subsp. lactis | ATCC 19435 |
| Lactococcus lactis subsp. cremoris | ATCC 19257 |
| Lactobacillus paraplantarum | ATCC 700211 |
| Lactobacillus delbrueckii subsp. delbrueckii | ATCC 9649 |
| Lactobacillus acidophilus | ATCC 4356 |
| Bifidobacterium infantis | ATCC 15697 |
| Lactobacillus casei | ATCC 393 |
| Lactobacillus paracasei subsp. paracasei | ATCC 25598 |
| Lactobacillus reuteri | BioGaia |
| Lactobacillus brevis | ATCC 14869 |
| Analytical Standards | Source |
| 3-Phenyllactic Acid | Sigma-Aldrich (#92267) |
| DL-p-hydroxyphenyllactic acid | Sigma-Aldrich (#H3253) |
| DL-indole-3-lactic acid | Sigma-Aldrich (#I5508) |
| Phenylpyruvic acid | Sigma-Aldrich (#74346) |
| 4-Hydroxyphenylpyruvic acid | Sigma-Aldrich (#114286) |
| Indole-3-pyruvic acid | Sigma-Aldrich (#I7017) |
| L-Phenylalanine | Sigma-Aldrich (#PHR1100) |
| L-Tyrosine | Sigma-Aldrich (#PHR1097) |
| L-Tryptophan | Sigma-Aldrich (#51145) |
| 4-hydroxyphenylacetic acid | Sigma-Aldrich (#55206) |
| 3-indoleacetic acid | Sigma-Aldrich (#45533) |
| Indole-3-proprionic acid | Sigma-Aldrich (#57400) |
| 3-phenylpropionic acid | Sigma-Aldrich (#W288918) |
| 4-hydroxyphenylpropionic acid | Sigma-Aldrich (#H52406) |
| Phenylacrylic acid | Sigma-Aldrich (#97013) |
| 4-hydroxyphenylacrylic acid | Sigma-Aldrich (#C9008) |
| 3-indoleacrylic acid | Sigma-Aldrich (#I2273) |
| Labeled Isotopes | Source |
| 4-hydroxyphenylpyruvic acid-13C9 | Sigma (#07491) |
| trans-Cinnamic acid-Î²,2,3,4,5,6-d6 | Sigma (#513962) |
| 3-indoleacetic acid-d5 chemical structure | MedChemExpress (#HY-18569S) |
| DL-3-phenyllactic acid-d3 | Toronto Research Chemicals Inc. (#P335567) |
| Metabolic Co-Factor | Source |
| Sodium phenylpyruvate | Sigma-Aldrich (#P8001) |
| 4-hydroxyphenylpyruvic acid | Sigma-Aldrich (#114286) |
| Indole-3-pyruvic acid | Sigma-Aldrich (#17017) |
| α-Ketoglutaric acid | Sigma-Aldrich (#75890) |
| Citric acid, trisodium salt dehydrate | Sigma-Aldrich (#227130010) |
| Yogurt Starter Culture | Source |
| YF-L706 | CHR-HANSEN (#704988) |
| Cell Line | Source |
| HepG2-Lucia ™ AhR Cells | InvivoGen (#hpgl-ahr) |

### Liquid Chromatography-Mass Spectrometry (LC/MS/MS)

Targeted analysis of aromatic amino acid metabolite from food samples/bacterial supernatants was performed by the Carver Metabolomics Core facility of the Roy J. Carver Biotechnology Center at UIUC. Briefly, chromatography was performed on a Vanquish UHPLC system (Thermo Scientific) with Gemini C6-Phenyl 110A column, 2×100 mm (3μ) column (Phenomenex); flow rate 600 μL/min. Mobile phases: 10 mM Ammonium acetate (A), 0.1% formic acid in Methanol (B). Gradient: 0-0.5 min—0% B, 0.5-3 min—100% B, 3-4.1 min—100% B, 4.1-5.5 min—0% B. The injection volume was 5 μL with the column chamber temperature at 40° C. Mass Spectrometry was conducted with a TSQ Altis MS/MS system (Thermo Scientific). Data was acquired in positive and negative SRM modes with peak integration and quantitation using Thermo TraceFinder software.

### Real-Time PCR

Store-bought fermented foods were prepared as described above. Using a spiral plater, MRS agar plates were streaked with diluted fermented food filtrates and cultured in an anaerobic chamber for 24-48 hours. Bacteria isolates were aseptically transferred to liquid MRS and grown in an incubator for an additional 24-48 hours. Bacteria isolates then underwent DNA isolation using AIIPrep Bacterial DNA/RNA/Protein Kit (Qiagen) according to manufacturer's instructions. Rt-PCR was completed with Power SYBR Green Master Mix (Thermo Fisher Scientific) and Lactobacillus primers from Kim et al. (2020). Differences in gene expression were determined by Real-Time PCR (Quantstudio 5, Thermo Fisher Scientific). Raw cycle threshold (CT) values determined abundance of relative Lactobacillus species.

### Bacterial Culture

Twenty strains (Leuconostoc citreum, Leuconostoc mesenteroides, Wiseella confusa, Lactococcus lactis, Streptococcus thermophilus, Bifidobacterium infantis, Lactobacillus species bulgaricus, plantarum, rhamnosus, and gasseri) were evaluated for aryl-lactate producing capacity. Lactobacilli were cultured in deMan, Rogosa and Sharp (MRS) broth; bifidobacteria were cultured under anaerobic conditions (90% N₂, 5% CO₂, and 5% H₂) in deMan, Rogosa and Sharp (MRS) supplemented with cysteine (0.05%); streptococci were cultured in M17 broth supplemented with 10% lactose. The cultures were incubated at 37° C. or 30° C. for 24 hours and 0.1% was transferred to 10 ml of sterile media and further incubated for 17 hours at same temperatures. Following incubation, samples were centrifuged at 16,102×g for 6 minutes, and cell-free supernatant was collected and filtered through 0.22 μm membrane. All samples were stored at −20° C. until they were submitted to the metabolomics core for targeted liquid chromatography-mass spectrometry analysis (LC/MS/MS). Two strains (Lactiplantibacillus plantarum ATCC 14917 and Bifidobacterium infantis ATCC 15697) were cultured as previously described. Subsequently, we evaluated the ability of these strains to produce aryl-lactates in the presence of specific key cofactors (5 mM): alpha-ketoglutarate (AKG), trisodium citrate dehydrate (CIT), and aryl-pyruvates [phenylpyruvic acid (PPyA), 4-hydroxyphenylpyruvic acid (HPPyA), and indole-3-pyruvic acid (IPyA)]. Samples were taken as previously described after 24 hours of growth in the supplemented media.

### Yogurt Preparation

Yogurt was produced in 1.5 ml centrifuge tubes to test aryl-lactate optimization by the addition of cofactors (AKG, CIT, PPyA, HPPyA, and IPyA) alone or combined with strains ATCC 14917 and ATCC 15697. Yogurt samples were prepared by reconstituting a 15% w/v mixture of skim milk powder (Millipore Sigma Skim Milk) with deionized water. The mixture first went through a heat treatment of 85° C. for 30 minutes. Subsequently, the milk temperature was cooled down to 40° C. before adding 0.44% starter culture (YF-L706 starter culture; Lactobacillus delbrueckii subsp. bulgaricus, Streptococcus thermophilus). Following inoculation, cofactors were added individually, in combination, or together with 2.5% each fresh overnight cultures v/v strains ATCC 14917 and ATCC 15697 before fermentation occurred at 42° C. for 5 hours. After fermentation and various time points (1- and 4-week storage at 4° C.), samples were centrifuged at 16,102×g for 6 minutes, and the resulting acid whey was collected by filtration through a 0.22 μm membrane. Samples were stored at −20° C. until submission for LC/MS/MS.

### Sauerkraut Preparation

Sauerkraut was produced in 50 mL Falcon tubes to test aryl-lactate optimization by the addition of cofactors (AKG, CIT, PPyA, HPPyA, IPyA) alone or combined with strains ATCC14917 and ATCC15697. Each cabbage was thoroughly washed, and its outer leaves were discarded. The cleaned cabbage was finely sliced, and salt (2.5% w/w) was evenly distributed over slices. After allowing them to rest for one hour, brine was separated from cabbage. To ensure proper fermentation, 10 mL of collected brine was reintroduced, completely submerging the cabbage. The cofactors were added into the samples in various combinations, either individually or concurrently with 2.5% v/v of aforementioned strains. All samples were thoroughly mixed, and solid phase microextraction (SPME) vial was inserted to ensure cabbage remained submerged during 10 d fermentation period at 20° C. After fermentation period, samples were centrifuged at 16,102×g for 6 minutes, and resulting acid was filtered through 0.22 μm syringe filters. Samples were stored at −20° C. until metabolomics analysis.

### AhR Reporter Cell Line Assays

Human HepG2 liver carcinoma AhR-Lucia reporter cells (InvivoGen) were cultured according to manufacturer's instructions. Aryl-lactates (PLA, 4HPLA, ILA) were reconstituted into solution with PBS (PLA, 4HPLA) or 1% DMSO (ILA), vortexed vigorously until dissolved, and serial diluted to desired concentrations. Fermented yogurt samples were prepared by centrifuging at 21,000×g for 10 minutes and supernatant was eluted through 0.22-micron filters. Sauerkraut samples were prepared by eluting liquid through 0.22-micron filters prior to being diluted 1:4 with PBS. Cell assay was performed according to manufacturer's instructions. Briefly, cells were counted (Invitrogen Countess) and reconstituted in media at concentrations of 1.1×10⁵ cells/mL. 180 μL of reconstituted cells were treated with 20 μl of sample in a 96-well plate and incubated at 37 C with 5% CO₂ for 17 hours. After incubation period, 20 μL of cell mixture was transferred to a white opaque 96-well plate and treated with 50 μL of QUANTI-Luc 4 Lucia/Gaussia (InvivoGen) and immediately read using luminescence at 0.1 second read time. Data was relativized to wells that contained cells with media alone.

### Statistical Analysis

Statistical analysis was performed by SPSS version 29 (IBM). Student t-tests and one-way/two-way analysis of variance (ANOVA) were utilized to test differences in aryl-lactates or AhR activity as described in figure legends. In cases of non-normal distributions, non-parametric Kruskal-Wallis H tests were utilized, and Dunnett's or Tukey post-hoc were implemented for multiple comparison testing. Data is expressed as mean±SEM with statistical significance statistical alpha set a priori at p<0.05 for all analyses.

### Example 2 Fermented Foods Identified as a Source of Microbial-Derived Aryl-Lactates: PLA, 4HPLA, and ILA

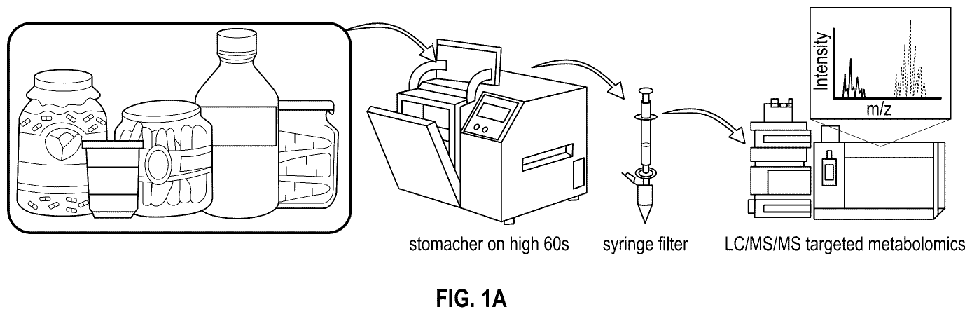

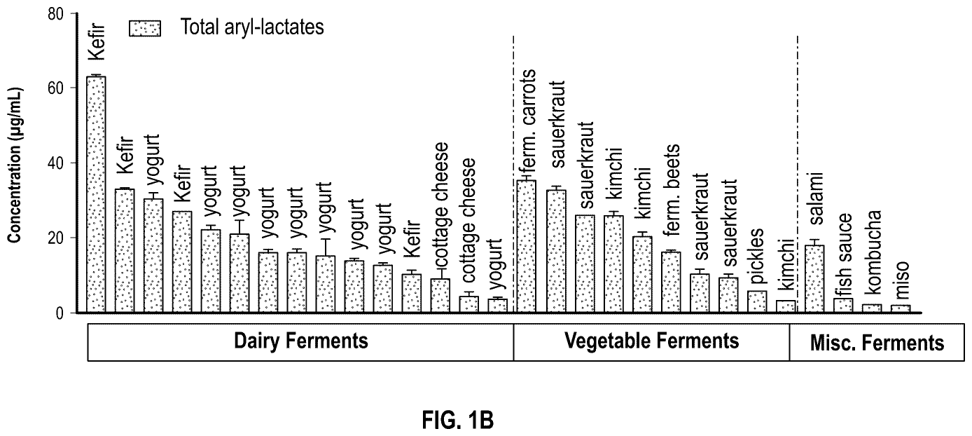

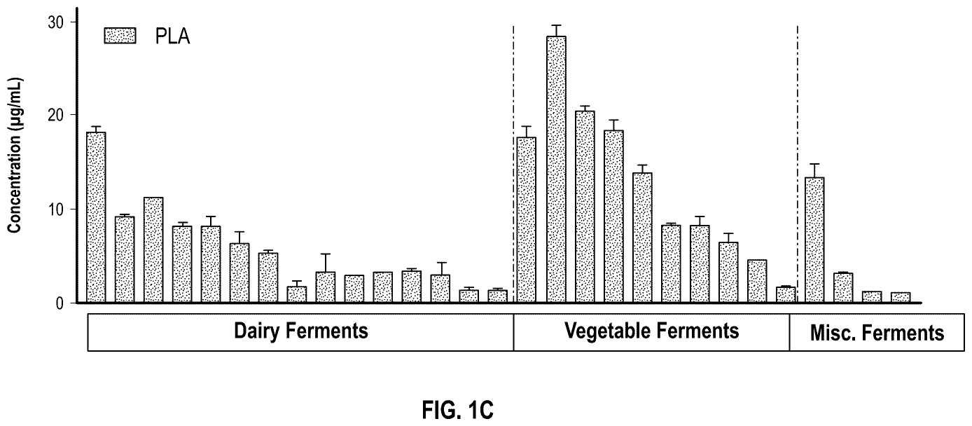

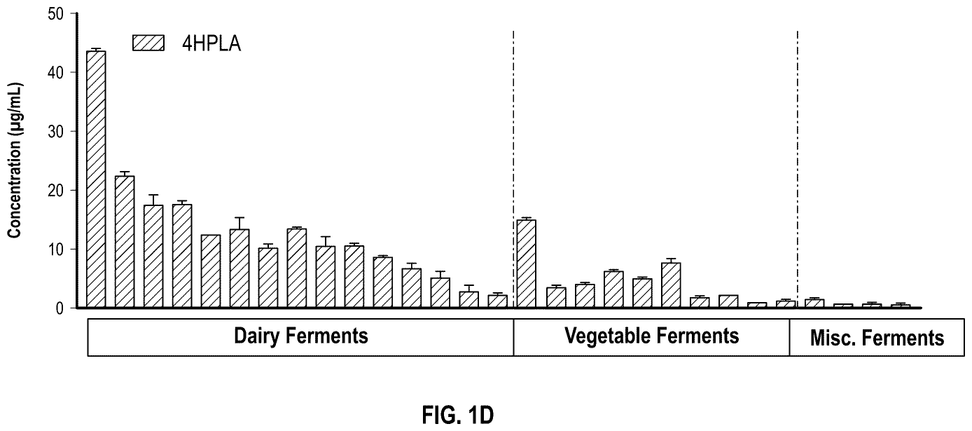

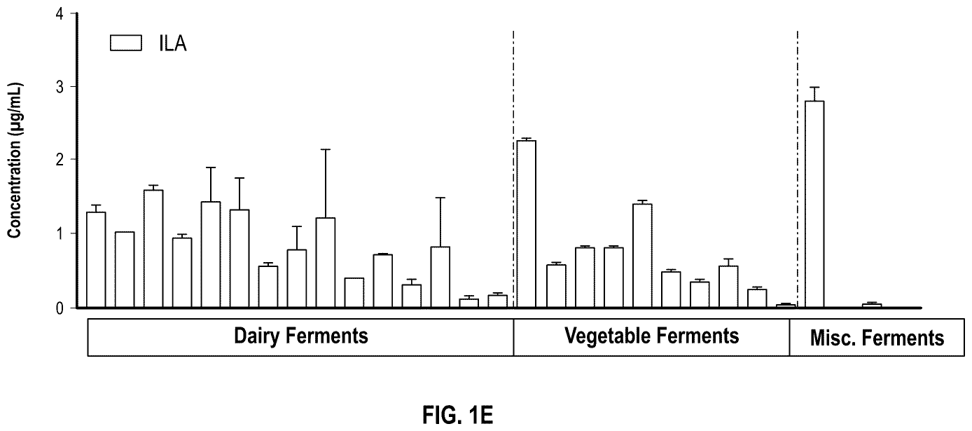

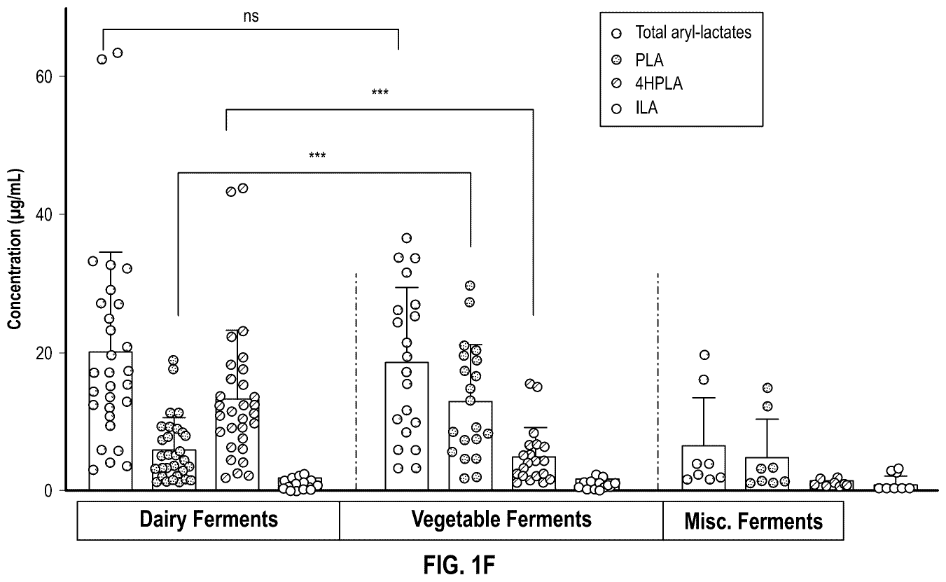

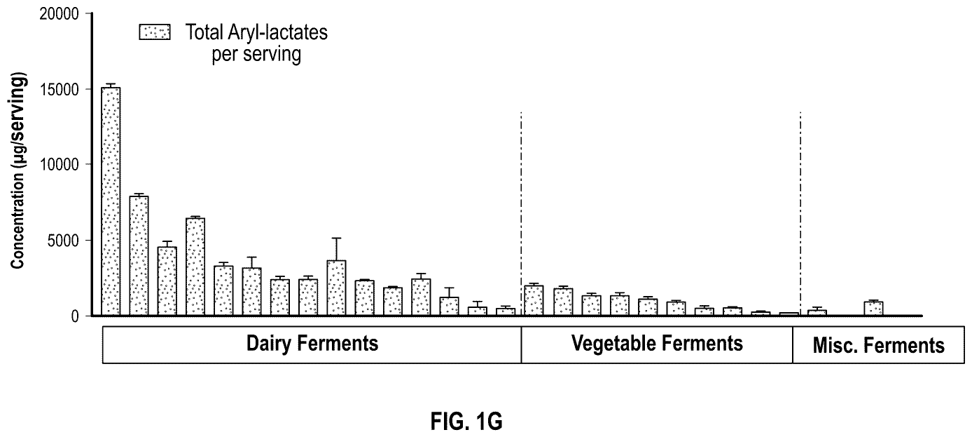

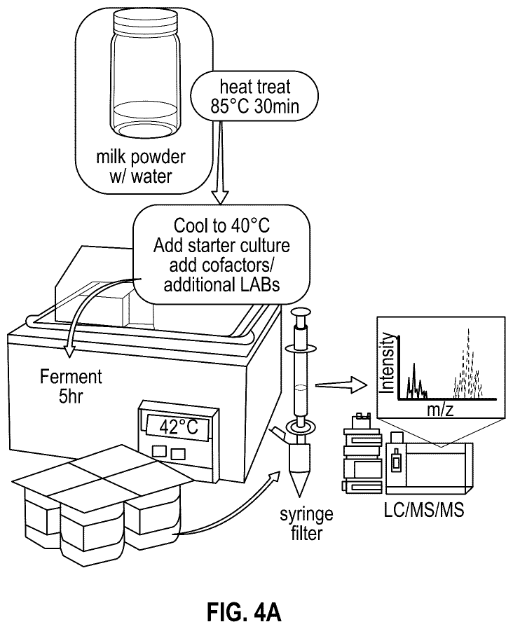

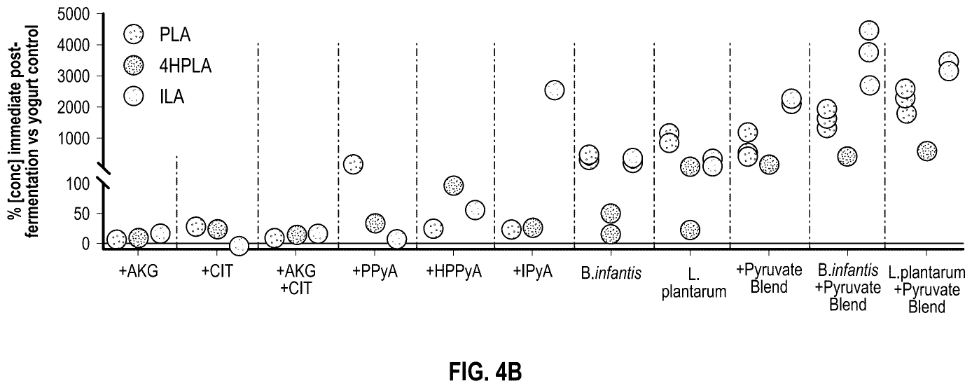

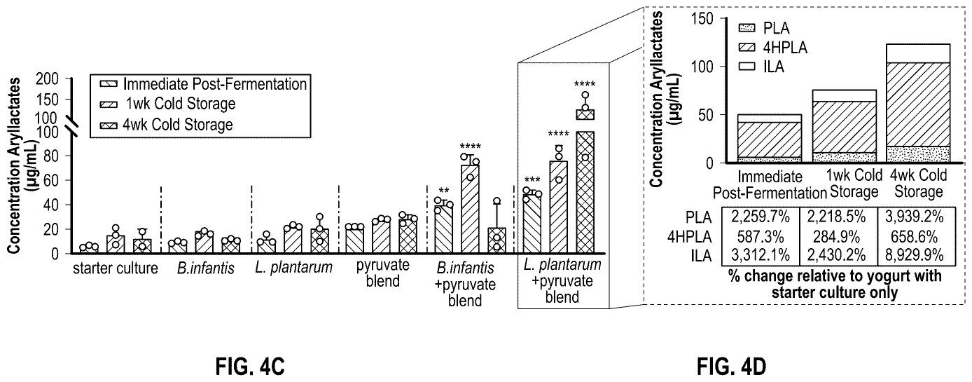

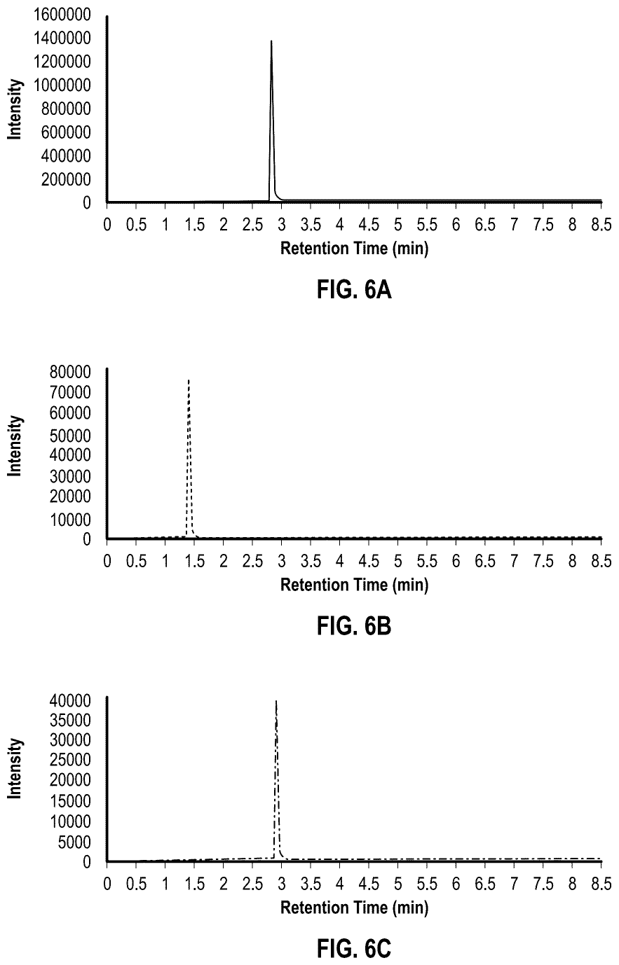

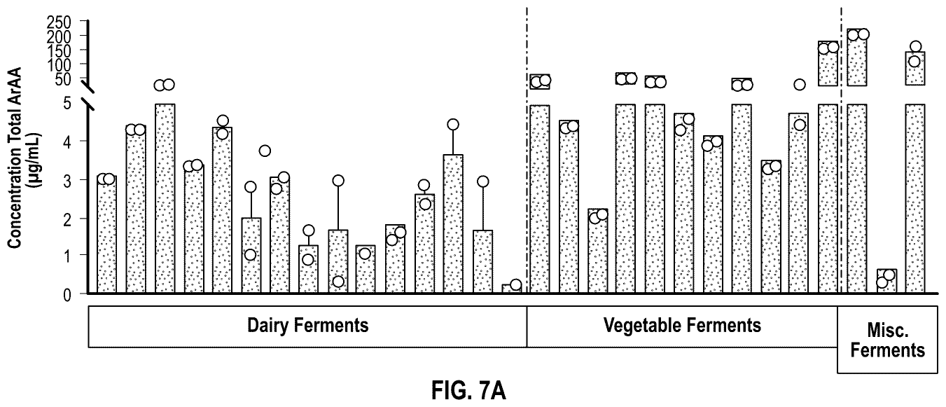

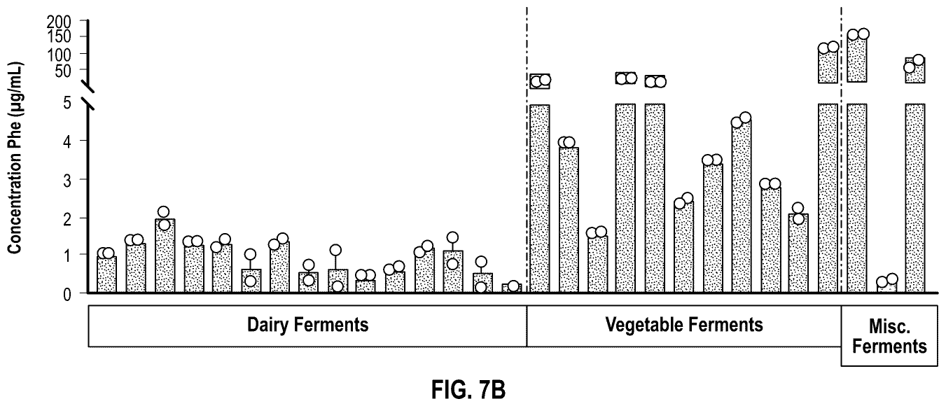

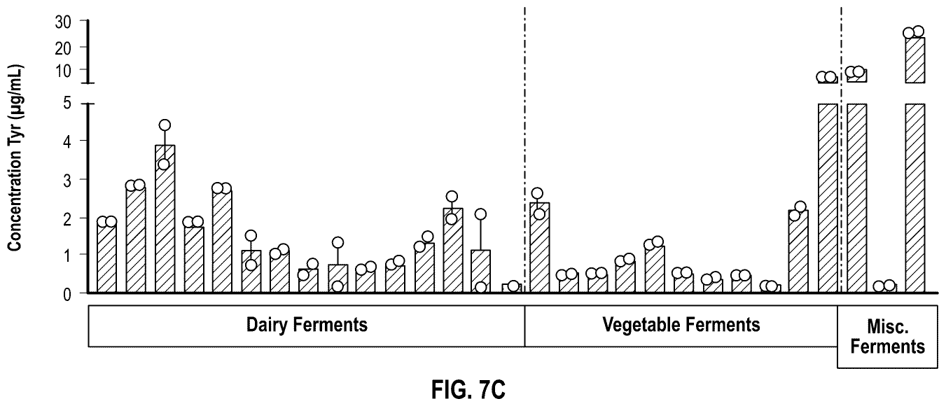

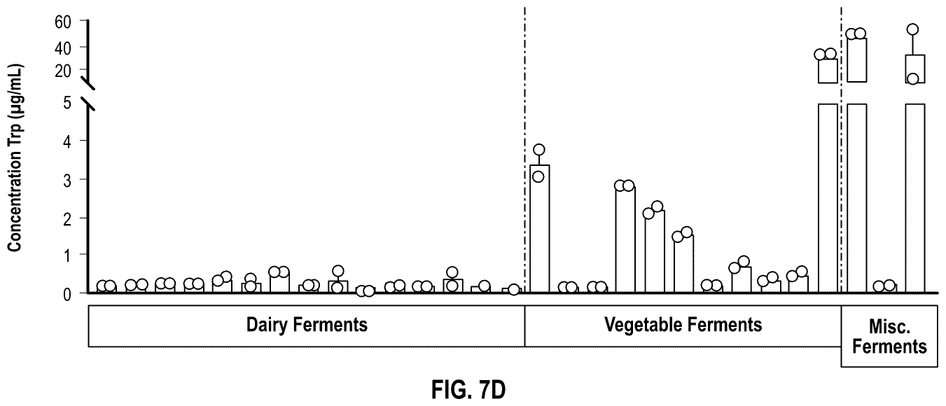

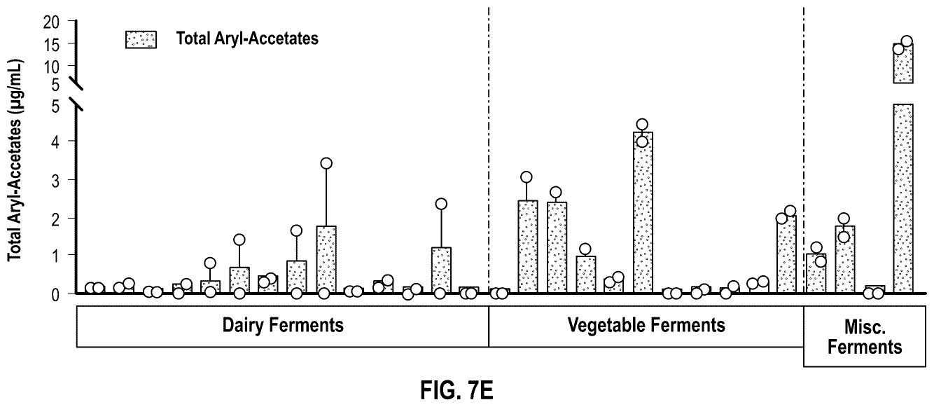

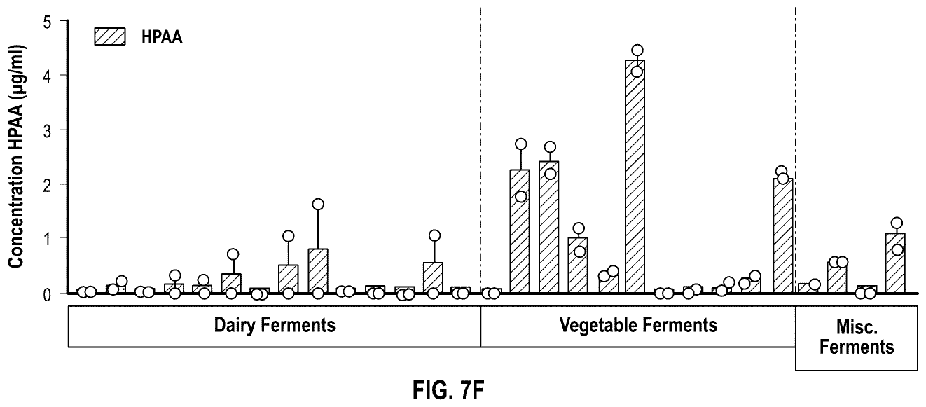

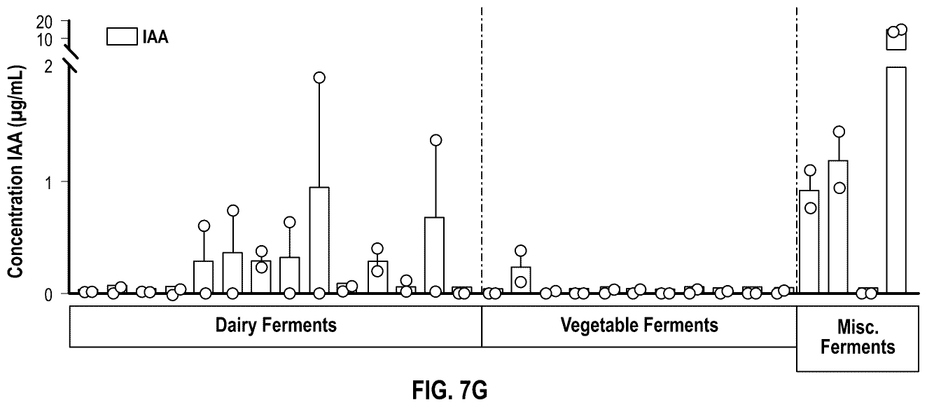

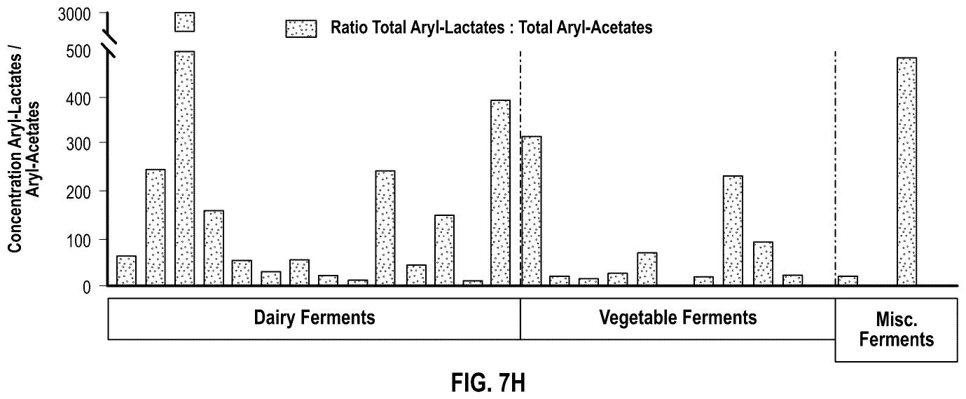

Fermented foods were purchased locally (Champaign, IL) including a variety of dairy (e.g., Greek yogurt, kefir), vegetable (e.g., Sauerkraut), and miscellaneous (e.g., animal protein, fish sauce) fermented products. We first examined whether aryl-lactates were present and their concentrations in these foods using a LC/MS/MS targeted metabolomics method (FIG. 1A, FIG. 6). We identified aryl-lactates derived from Phe (phenyllactic acid—PLA), Tyr (4-hydroxyphenyllactic acid—4HPLA) and Trp (indole-3-lactic acid—ILA) present in nearly all fermented foods tested, but in varying amounts depending on the food type and source (FIG. 1B-E). The dairy ferments with the highest aggregate levels of aryl-lactates (PLA+4HPLA+ILA) included kefir and select Greek yogurts (FIG. 1B). The vegetable ferments with the highest aggregate aryl-lactates were fermented carrots and select brands of sauerkraut (FIG. 1B). Miscellaneous ferments (e.g., fish sauce, kombucha) contained on average ˜4-6-fold lower aryl-lactates compared to vegetable or dairy ferments (FIG. 1B). PLA (0.17-28.4 μg/mL; FIG. 1C) and 4HPLA (0.4-43.7 μg/mL; FIG. 1D) were the most representative aryl-lactates across all fermented food sources. ILA (0-2.8 μg/mL; FIG. 1E) was the least present aryl-lactate in all fermented foods, representing a bias towards Phe and Tyr metabolism in whole food matrices or related to the concentrations of the ArAAs in the whole foods (FIG. 1F, FIG. 7). Aryl-acetates (phenylacetate—PAA, 4-hydroxyphenylacetate—HPAA, and indole acetate—IAA) are downstream of oxidative metabolism of ArAAs and were present in only a fraction of the concentration within fermented foods as compared to aryl-lactates (PAA was not-detected in all foods; total aryl-acetates 0-14.93 μg/mL; FIG. 7E-H). While the total aryl-lactate concentration in dairy vs vegetable ferments were not different, normalized concentrations of aryl-lactates were dependent on the source of the whole food. Dairy ferments exhibited significantly more 4HPLA, while vegetable ferments contained more PLA (FIG. 1F; p<0.001). We also determined aryl-lactate concentrations per serving size. (Wastyk et al., 2021b) Because fermented dairy serving sizes are larger than those of fermented vegetable products, an average serving of dairy ferments contains more aryl-lactates than one serving of vegetable ferments (FIG. 1G; p<0.01).

Bacteria Strains with Aryl-Lactate Producing Capacity are Present in Commercially Sold Fermented Food Products.

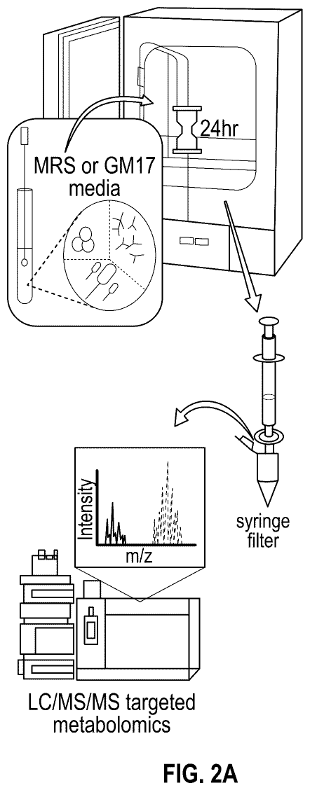

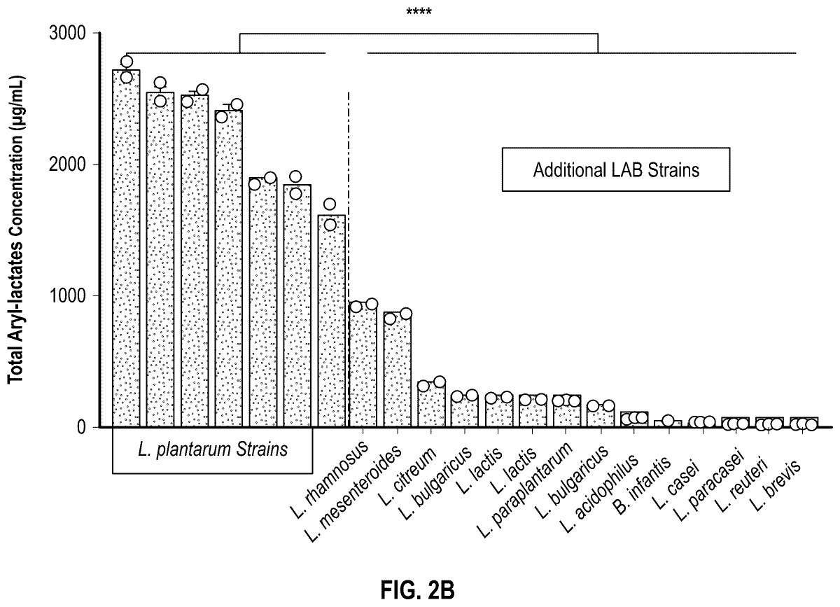

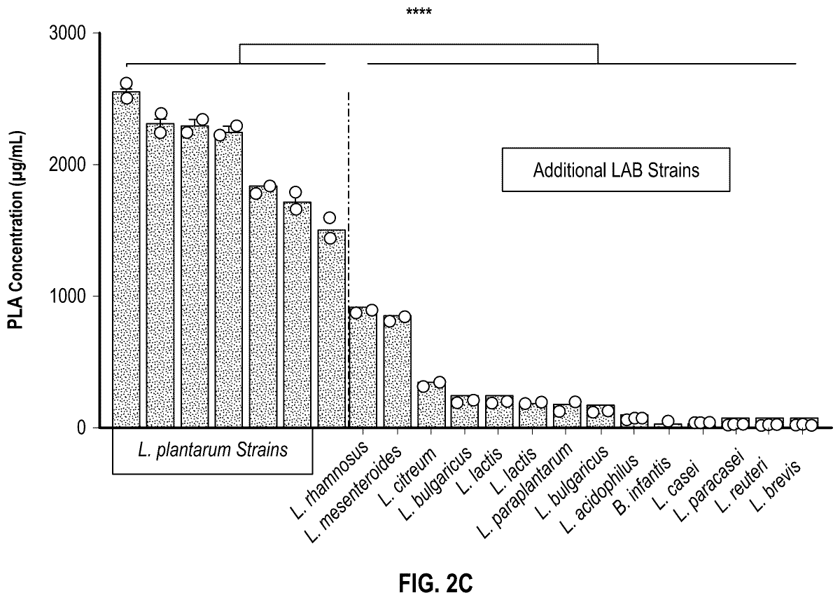

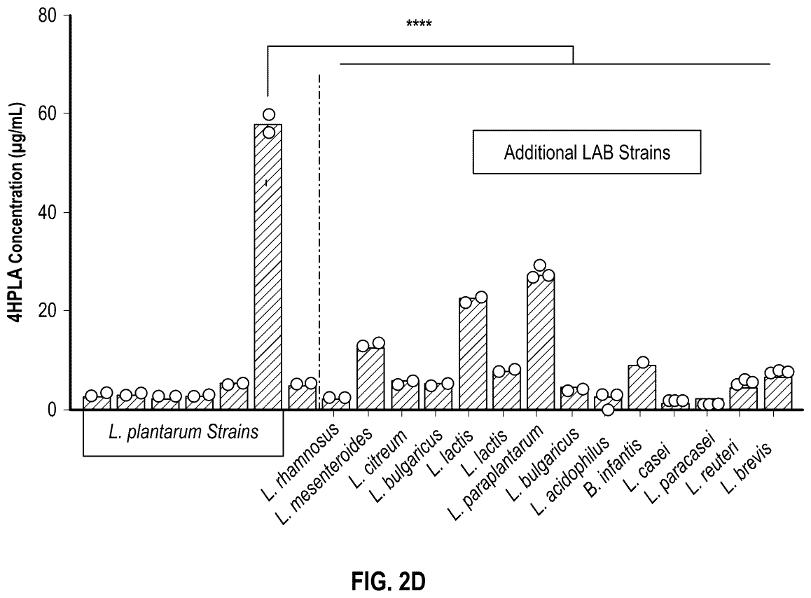

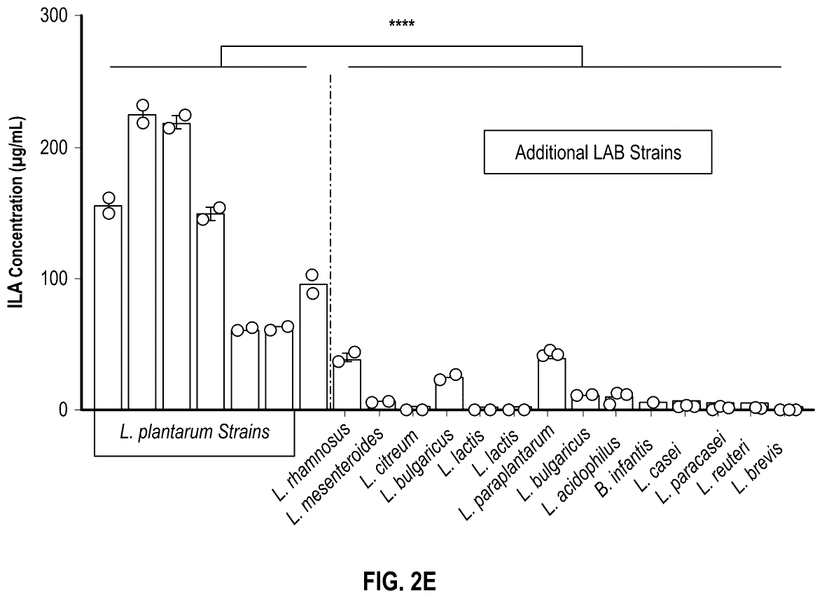

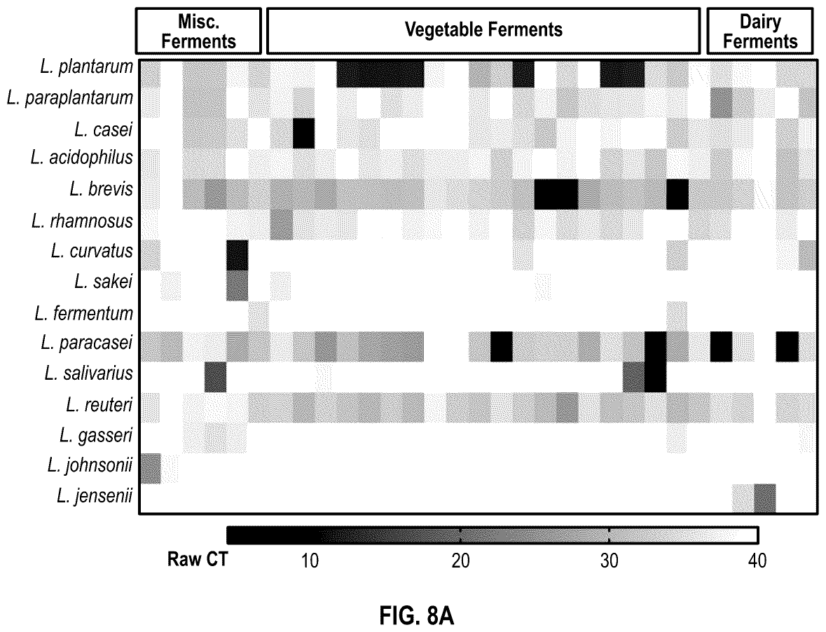

After identifying the presence of PLA, 4HPLA, and ILA in various fermented foods, we next investigated the potential bacterial sources of aryl-lactate production within fermented foods. We cultured the ferments anaerobically and isolated DNA from bacteria isolates. Using qPCR, we targeted a panel of lactic acid bacteria (LAB) species commonly found in fermented foods (Kim et al., 2020). qPCR identified a variety of LABs across food sources. Within the foods with the highest aryl-lactates, the most common and abundant bacteria isolates were Lactiplantibacillus plantarum (L. plantarum), followed by Lactobacillus brevis and Lacticaseibacillus paracasei (FIG. 8). We next sought to determine ability of select LAB strains found in fermented foods (including 7 strains of L. plantarum) to directly produce aryl-lactates. After 24 hr monoculture in standard MRS or GM17 media, supernatant was analyzed using LC/MS/MS for concentrations of aryl-lactates (FIG. 2A-E). In accordance with its presence in foods with high amounts of aryl-lactates, all tested L. plantarum strains produced significantly higher amounts of total aryl-lactates, PLA, and ILA compared to other LABs tested (FIG. 2B-C, E p<0.0001).

### Select Co-Factor and Precursor Metabolites Shift LAB Metabolism Towards Increased Production of Aryl-Lactates.

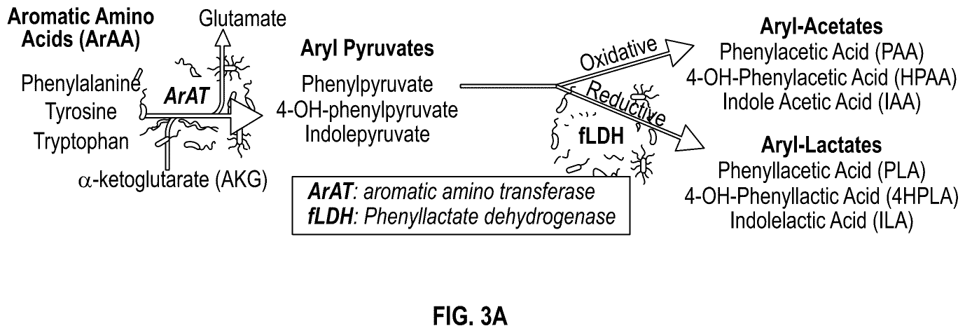

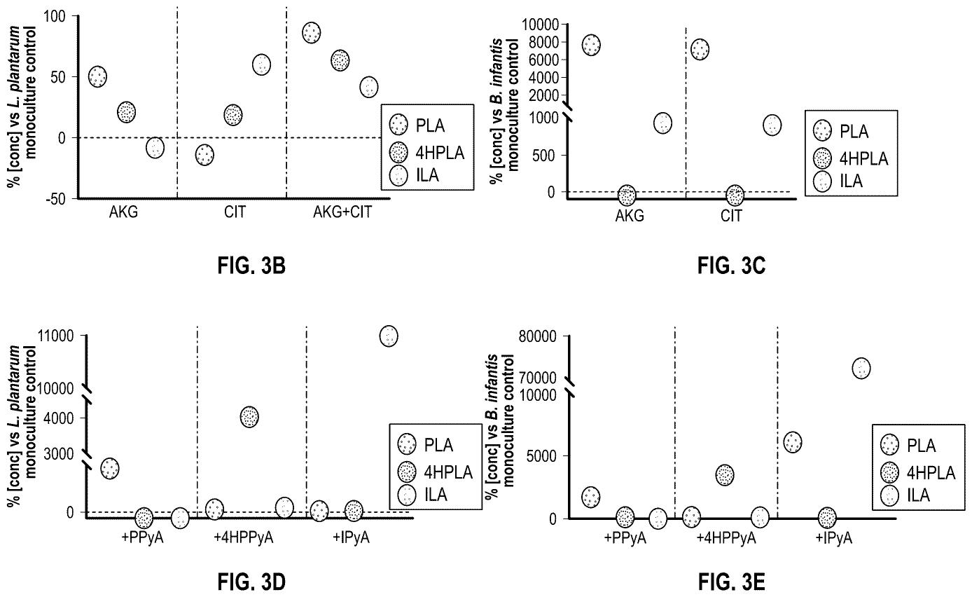

We next worked to optimize the metabolism of ArAA to favor the production of aryl-lactates in monoculture. We focused on the LAB L. plantarum because of its capability to produce high concentrations of aryl-lactates in monoculture as well as its commonality within both wild and non-wild fermented foods (Marco et al., 2021 b). We also chose to investigate the LAB B. infantis not only to determine if different bacteria react in varying manners to metabolism manipulation, but also because of its prevalence and physiological importance in the human gut microbiome (O'Brien et al., 2022; Vatanen et al., 2022). Since alpha-ketoglutarate (AKG) is a nitrogen acceptor in the metabolism of amino acids (FIG. 3A) and citrate (CIT) potentially stimulating ArAA catabolism, (Dallagnol et al., 2011a) we added both cofactors individually and in combination to L. plantarum and B. infantis monoculture to determine if they increase the production of aryl-lactates and could be limiting factors in the metabolism of these metabolites. The combination of both AKG and CIT increased the production of aryl-lactates in L. plantarum monoculture by 42-86%, with PLA exhibiting the most robust increase compared to monoculture with no additives (FIG. 3B). Aryl-lactates production by B. infantis were significantly more sensitive to AKG and CIT compared to L. plantarum, exhibiting >7,000-fold increase in PLA and >900-fold increase in ILA compared to the control B. infantis culture with no AKG or CIT (FIG. 3C).

ArAAs are metabolized by select bacteria to aryl-pyruvates via the aromatic aminotransferase (ArAT) enzyme and are subsequently metabolized to aryl-lactates via microbial enzyme phenyllactate dehydrogenase (fLDH) (FIG. 3A). In an effort to enhance the production of aryl-lactates in LAB cultures, we next added aryl-pyruvates (phenylpyruvate [PPyA], 4-hydroxyphenylpyruvate [HPPyA], or indole-3-pyruvate [IPyA]) to L. plantarum and B. infantis. Interestingly, in almost all cases when the upstream aryl-pyruvate was added, the respective downstream aryl-lactate was robustly increased while the other two aryl-lactates exhibited slight, or no change compared to control culture (FIG. 3D-E). For example, when indole pyruvate (IPyA) was added to either a L. plantarum or B. infantis monoculture, ILA increased in production ˜10,000% and ˜7,500%, respectively, compared to L. plantarum or B. infantis monoculture without IPyA addition (FIG. 3D-E).

### Manipulation of ArAA Metabolism Transfers to Whole Fermented Food Matrices and is Optimized Further Across Commercially Relevant Storage Times.

We next examined whether aryl-lactate metabolism could be modified in a whole fermented food matrix. We first focused on yogurt because 1) we established it as a source of aryl-lactates and 2) it has a known and well-established starter culture (S. thermophilus and L. bulgaricus) compared to other dairy and vegetable ferments. Yogurt (Starter culture only: 0.4% w/v of 1×10⁷ CFU/mg L. bulgaricus, S. thermophilus) was fermented for 5 hours prior to sampling at three timepoints: immediate post-5 hr fermentation, 1-week cold storage and 4-weeks cold storage (FIG. 4A). Aryl-lactate concentrations in starter culture only conditions were compared to yogurt conditions where we added bacterial strains, co-factors and metabolites to the starter culture: AKG and/or CIT, B. infantis or L. plantarum alone, individual aryl-pyruvates (PPyA or HPPyA or IPyA), pyruvate blend (PPyA+HPPyA+IPyA), and L. plantarum or B. infantis with pyruvate blend. First, we examined aryl-lactate production immediately post 5 hr fermentation (FIG. 4B). We found that AKG or CIT marginally increased the production of aryl-lactates compared to control yogurt (4-27%). The addition of LABs B. infantis or L. plantarum robustly upregulated aryl-lactate production with 3.4-fold change on average compared to control yogurt. For example, we observed a 1,000% increase in PLA in yogurt with L. plantarum added (FIG. 4B). Mirroring what we observed in LAB monoculture, addition of individual aryl-pyruvates to yogurt robustly enhanced each respective downstream aryl-lactate (e.g., added IPyA: ˜25-fold increase in ILA), while the production of other aryl-lactates exhibited less change (e.g., added IPyA: 0.24-fold increase in PLA, 0.26-fold increase in 4HPLA) (FIG. 4B). Meanwhile, adding all aryl-pyruvates to yogurt culture together increased all downstream aryl-lactates on average 10-fold vs yogurt control where no aryl-pyruvates were added (FIG. 4B). The most effective conditions tested for promoting aryl-lactate concentrations in a whole fermented food matrix was the addition of bacterial aryl-lactate producer (L. plantarum or B. infantis) in combination with a blend of aryl-pyruvates. The addition of L. plantarum and aryl-pyruvate blend to yogurt with starter culture robustly increased all aryl-lactates [PLA (2,260%), 4HPLA (580%), and ILA (3,312%)] as compared to yogurt fermented with starter culture only (FIG. 4B, p≤0.0001).

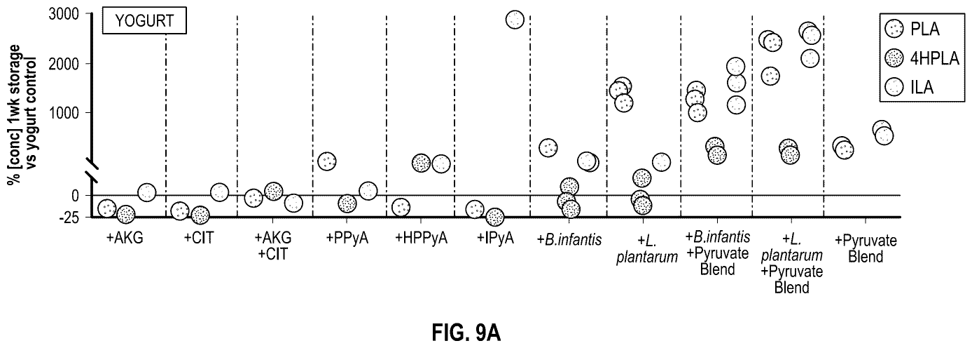

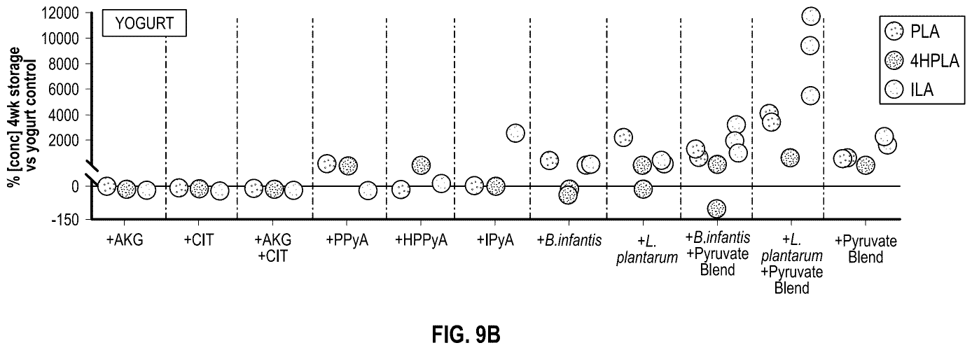

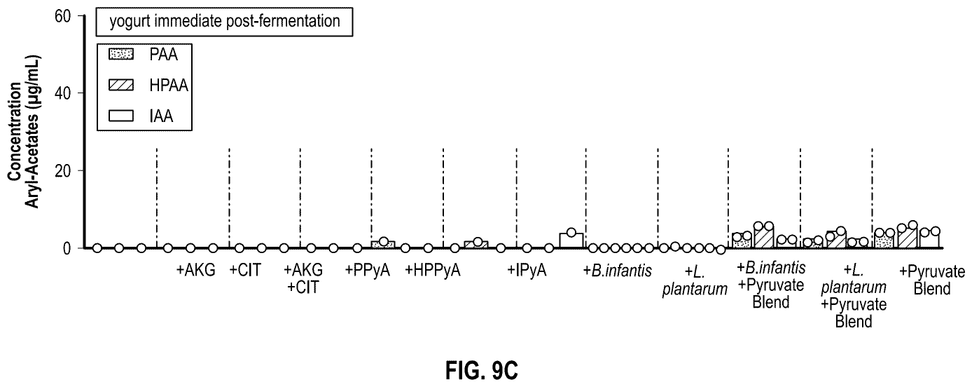

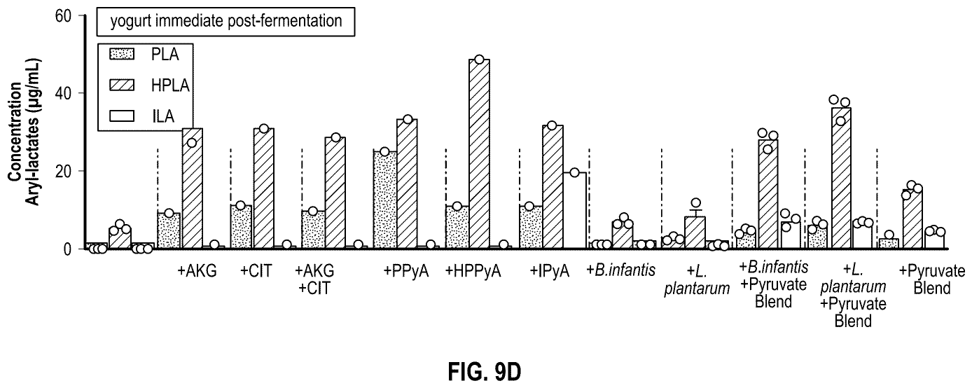

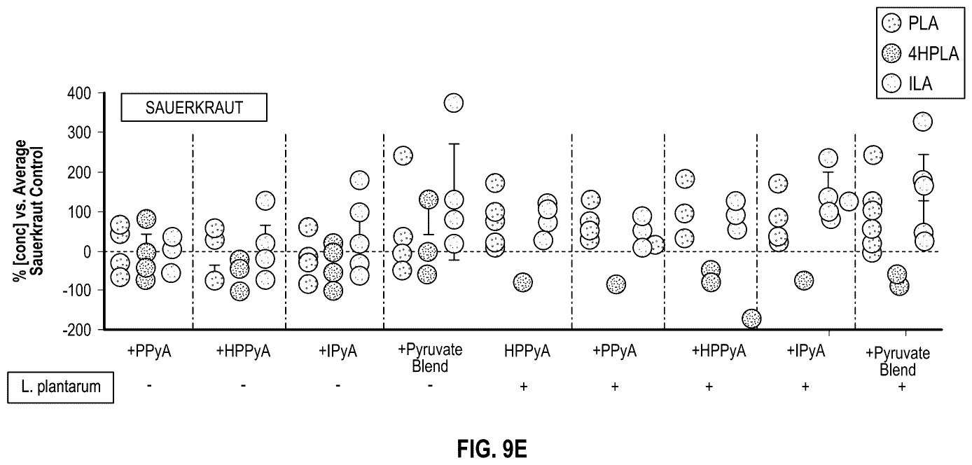

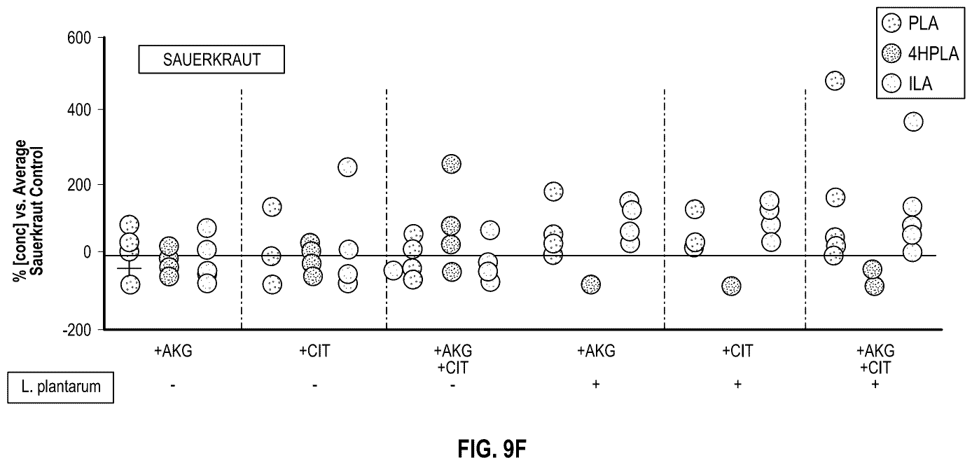

Storage conditions and time can impact bioactive metabolites in food (Tan et al., 2020). Thus, we next tested: 1) whether total aryl-lactates changed over a commercially relevant storage time (1-4 weeks) and 2) if conditions best optimized to produce aryl-lactates immediately after fermentation could improve aryl-lactate maintenance across storage time (FIG. 4C-D, FIG. 9A-B). In the starter culture only condition, aryl-lactates were maintained at similar levels after 4 weeks of storage compared to immediately post fermentation, indicating that aryl-lactate concentrations are relatively stable during 4 wks cold storage. The addition of select aryl-lactate producing bacteria (B. infantis, L. plantarum) did not significantly increase the production of aryl-lactates, nor did it impact total aryl-lactate concentrations across cold storage (FIG. 4C; p>0.05). Similarly, the addition of pyruvate blend alone did not change total aryl-lactate concentration compared to yogurt with starter culture only. The production of aryl-lactates within yogurt significantly increased when an aryl-lactate producing bacteria was added in conjunction with aryl-pyruvate blend immediate post-fermentation period (FIG. 4C; B. infantis+pyruvate blend p<0.01, L. plantarum+pyruvate blend p<0.001). The addition of upstream aryl-pyruvates also increased aryl-acetates vs control (average increase from 0.0015 to 2.42 μg/mL), but the effect was minimal compared to the increases in aryl-lactates (average increase from 1.91 to 16.22 μg/mL), suggesting a favorable reductive metabolism in fermented food matrices (FIG. 9C-D). The addition of individual ArAAs to yogurt robustly enhanced each respective downstream aryl-lactate, while the production of other aryl-lactates exhibited less change. Meanwhile, adding all ArAAs alongside L. plantarum to yogurt together increased all downstream aryl-lactates [PLA (2,595%), 4HPLA (380%), ILA (3,495%) compared to yogurt with starter culture only (FIG. 4E). Overall, L. plantarum added in combination with the aryl-pyruvate blend was found to be most effective at maintaining aryl-lactates during cold storage. For example, L. plantarum+aryl-pyruvates yielded ˜9,000% fold increase in ILA after 4 weeks of cold storage compared to the starter culture only (FIG. 4D).

Next, we tested if aryl-lactate production could be fostered in a different fermented food matrix, sauerkraut. Unlike yogurt, sauerkraut is produced from a vegetable (cabbage) and undergoes fermentation from resident bacteria found naturally on the food (i.e., no starter cultures are added). To test this, we added a variety of metabolic co-factors (e.g., AKG and/or CIT, aryl-pyruvates) with or without the addition of LAB producers (e.g., L. plantarum) prior to a spontaneous cabbage fermentation for 10 days. Compared to standard sauerkraut fermentation conditions, aryl-lactates were enhanced by 41-125% after 10 days of fermentation with our optimization conditions (FIG. 9E-F). We also found that the combination of cultures with metabolic co-factors could synergize to enhance aryl-lactate production. For example, the addition of L. plantarum with the aryl-pyruvate blend resulted in enhanced PLA (94%) and ILA (129%) production compared to sauerkraut control (p<0.01). Moreover, the addition of AKG and CIT had little effect on aryl-lactate production when added alone, yet these same metabolites were effective at increasing aryl-lactate levels when added alongside L. plantarum prior to sauerkraut fermentation (FIG. 9E).

### Example 3 Manipulating Microbial Aromatic Amino Acid Metabolism Promotes Fermented Food Matrix Capacity to Activate the Human Aryl-Hydrocarbon Receptor (AhR)

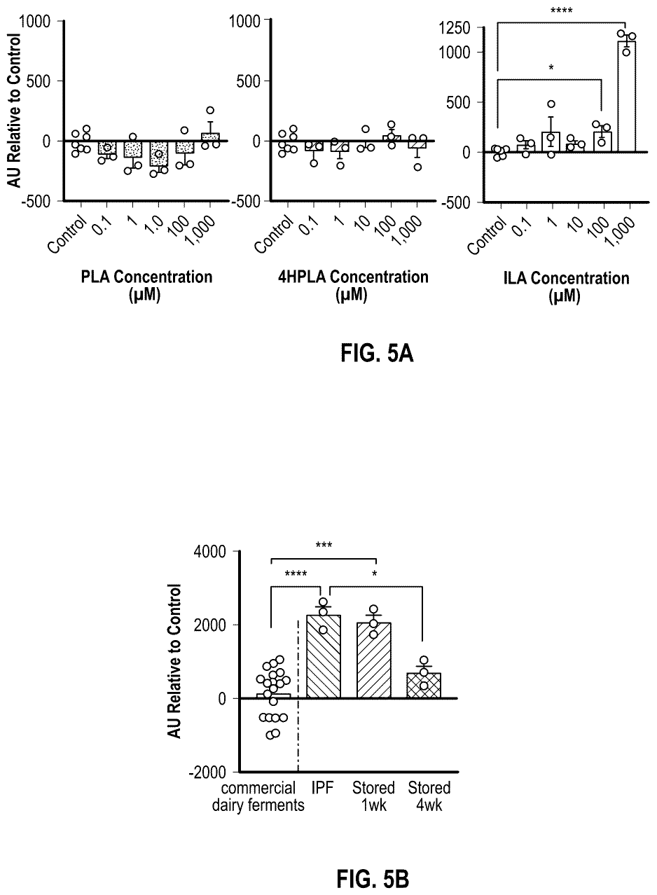

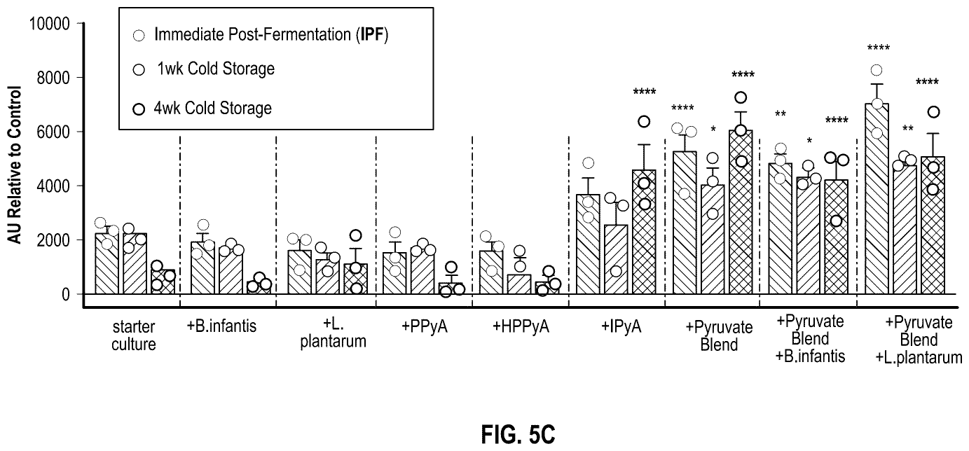

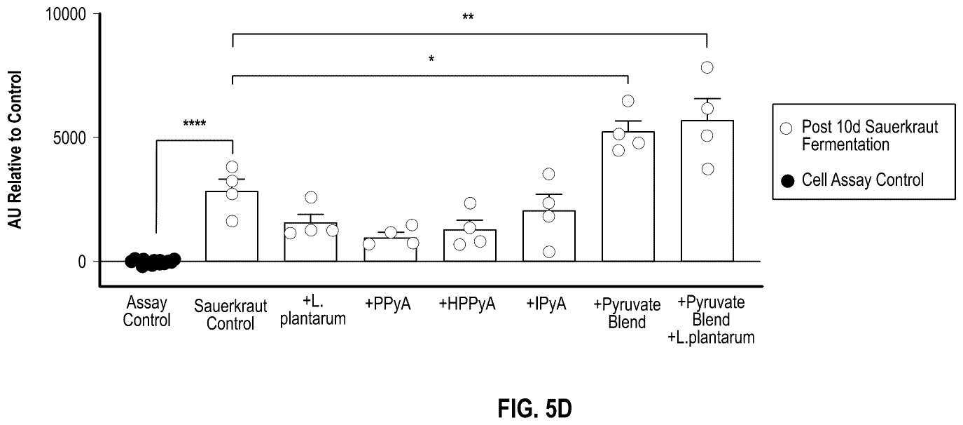

We next aimed to identify the bioactivity of aryl-lactates found in fermented foods. The aryl-hydrocarbon receptor (AhR) is a ligand-dependent cytoplasmic receptor that translocates to the nucleus upon ligand binding and has been recognized as a key regulator in homeostatic processes at barrier sites, such as in the intestines (Stockinger et al., 2021). Many indole compounds that are derived from the ArAA tryptophan have been identified as AhR ligands (Stockinger et al., 2021). To determine which aryl-lactates activate AhR, we added increasing concentrations of aryl-lactates (0.1 μM-1 mM) to an ex vivo AhR reporter cell line (HepG2 Lucia, Invivogen), and found only ILA enhances AhR activation at concentrations ≥100 μM (p<0.05), whereas PLA and 4HPLA failed to activate the receptor (p>0.05; FIG. 5A).

We next investigated whether whole food matrices exhibited activity against human AhR. We first compared AhR activity in 9 store-bought dairy ferments compared to an in-house laboratory made yogurt with common starter cultures as described previously utilizing HepG2 AhR cells. With our lab-made yogurt, AhR activity was measured at three (3) time points: 1) immediate post-5 hr fermentation, 2) 1 wk cold storage and 3) 4 wk cold storage. We found that AhR activity in commercial ferments was detectable, but also highly variable. Some fermented products exhibited AhR activity, while others either showed AhR inhibitory activity or had the same AhR activity as the assay control (FIG. 5B). Our laboratory-produced yogurt containing starter culture exhibited higher AhR activity compared to all commercial dairy ferments immediately post fermentation (FIG. 5B; p<0.001). However, after 4 weeks of cold storage, AhR activity declined to levels within range of commercial dairy ferments (FIG. 5B; p>0.05).

Next, we treated HepG2 AhR cells with yogurts optimized to favor production of aryl-lactates. Compared to the decrease in AhR activity after 4 wk of storage in yogurt with starter culture only, certain yogurt treatments, including added L. plantarum, IPyA, and pyruvate blend with and without added B. infantis or L. plantarum, mitigated the decrease of AhR activity over time, resulting in steady AhR activity over 4 wk of cold storage (FIG. 5C). Most notably, after 4 wk of cold storage, the yogurts treated with IPyA, a metabolite we previously found to increase ILA, enhanced yogurt AhR activity more than 6-fold compared to yogurt inoculated with starter culture only (FIG. 5C; p<0.0001). Furthermore, yogurt with added aryl-lactate producing bacteria (L. plantarum, B. infantis) in conjunction with added pyruvate blend significantly enhanced AhR activity immediately post fermentation period and throughout cold storage (FIG. 5C; p<0.001). This suggests that optimizing products to increase the production of aryl-lactates, especially ILA, will preserve biological activity of a whole fermented food matrix over extended periods of storage.

To strengthen our observations, we next tested whether our strategies to increase aryl-lactate production could similarly enhance food AhR activity in a different food matrix, sauerkraut. Using the same AhR reporter assay described above, we first found that our control sauerkraut ferment elicited significant AhR activity as compared to media control, even without added treatments (FIG. 5D; p<0.0001). Encouragingly, we found that manipulated fermentation conditions that favored aryl-lactate production, most notably the addition of an aryl-pyruvate blend with an aryl-lactate producing L. plantarum, further enhanced AhR activity of sauerkraut compared to the control wild ferment (FIG. 5D; p=0.0075). Therefore, bioactivity of fermented foods, exemplified here in both yogurt and sauerkraut, can be enhanced with conditions that shift microbial ArAA metabolism towards aryl-lactate production.

Furthermore, utilizing an optimized PRESTO-Tango (Addgene Kit #1000000068) G-protein coupled receptor (GPCR) activation assay, we confirmed that two of the three aryl-lactates bind human hydroxycarboxylic receptor 3 (HCAR3) which is implicated in immune cell responses and metabolic health. Specifically, PLA and ILA both displayed the ability to bind HCAR3 while the signaling of 4-HPLA remains unresolved (FIG. 5E).

### Example 3 Discussion

Within commercial fermented foods, we observed variation of total aryl-lactate concentrations in food types (e.g., yogurt; 3.75-30 μg/mL total aryl-lactates), likely related to differences in the LAB strains present within the various brands. We found L. plantarum to not only be a high producer of aryl-lactates in monoculture, but also identified it as a LAB present in many of the examined commercial fermented foods. L. plantarum has also been identified as a highly malleable LAB which likely explains its presence in a wide variety of fermented foods (Tejedor-Sanz et al., 2022; Yilmaz et al., 2022). While we also found B. infantis as capable of producing aryl-lactates, this bacteria species is mainly studied in the context of the microbiome and has not been investigated much in the context of fermented foods.

We found that aryl-lactate profiles varied depending on food origin—e.g., dairy versus vegetable ferments. Dairy products exhibited high levels of 4HPLA (vs. PLA), whereas vegetable ferments exhibited higher levels of PLA. This phenomenon was present in both commercial fermented foods, and the laboratory-grown sauerkraut and yogurt controls. The dairy starter culture (S. thermophilus and L. bulgaricus) may have enhanced affinity to metabolize Tyr to 4HPLA in comparison to the bacteria found in plant ferments, which appear to have increased affinity to metabolize Phe to PLA. Optimization techniques used herein had relatively lower impact on 4HPLA production versus other aryl-lactates in both yogurt and sauerkraut matrices (e.g., 587% increase in 4HPLA in yogurt with added L. plantarum+pyruvate blend immediate post-fermentation in comparison to 2,260% increase in PLA and 3,312% increase in ILA). Similarly, we found that despite ILA levels being the lowest concentrated aryl-lactate in both commercial foods and laboratory-grown ferments, this metabolite changed the most with our optimization techniques. For example, yogurt with added IPyA exhibited 2,566% increase in ILA while yogurt with added PPyA exhibited only a 183% increase in PLA concentrations versus control. With this data, we predict that fLDH has preferred substrates depending on the different LABs found within food sources, with LAB within dairy preferring Tyr and HPPyA and LAB within vegetable ferments preferring Phe and PPyA.

Herein, we demonstrate that promoting microbial ArAA metabolism to produce aryl-lactates can enhance bioactivity of food matrix as measured by human aryl-hydrocarbon receptor (AhR) activity. We also demonstrated that fermented food AhR bioactivity can be predictably preserved throughout four weeks of cold storage by enhancing microbial ArAA metabolism. This contrasts with store-bought food sources that showed highly variable AhR bioactivity, with many foods below detectable activity. Therefore, optimization of fermented foods for aryl-lactate production has the potential to improve bioactivity of foods over typical shelf life. This may have important implications for human health, as depleted microbial AhR activity has recently emerged as a key sign of chronic inflammatory diseases, including inflammatory bowel diseases and obesity. We thus envision that optimizing fermented foods for enhanced production of aryl-lactates to promote AhR activity may be a unique tool for combating microbial dysbiosis associated with chronic disease.

### Example 4

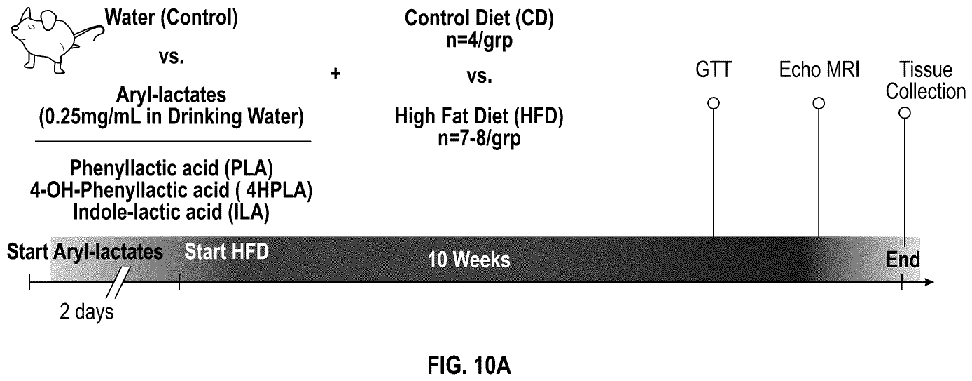

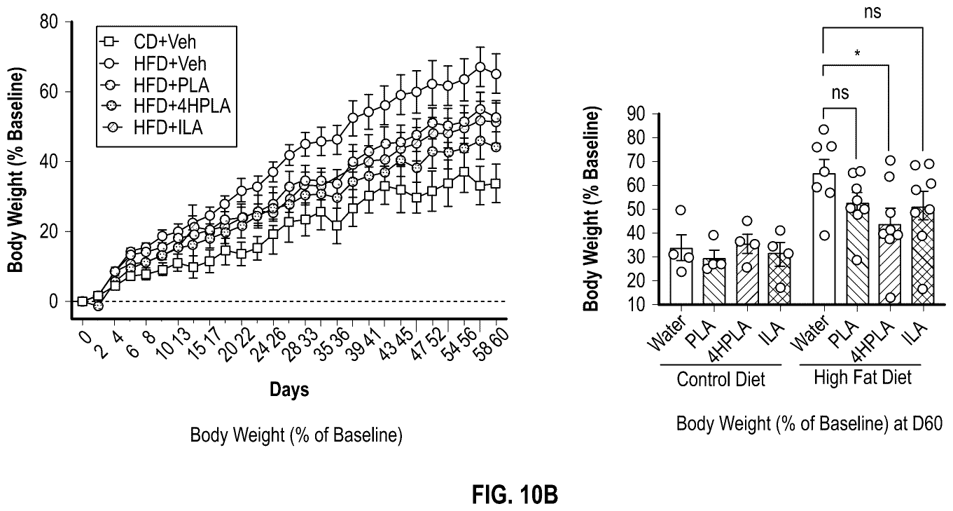

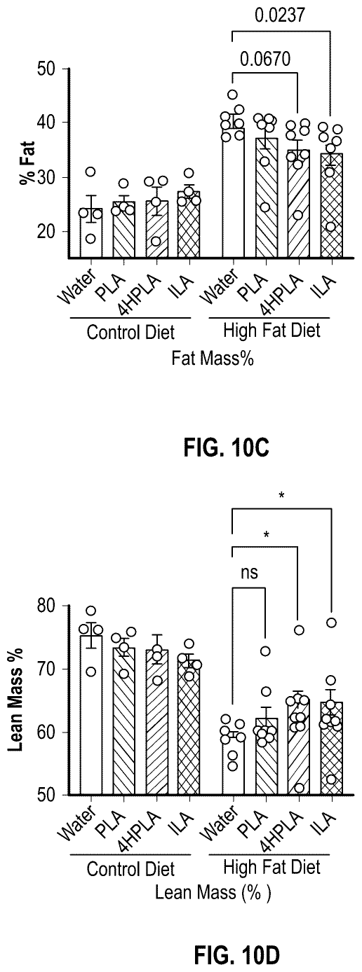

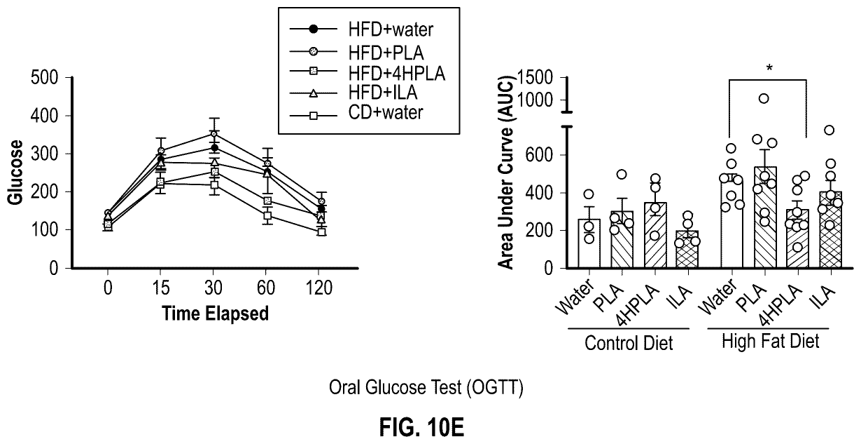

10-12 wk old C57B16 mice were randomized to water control or Aryl-lactates (PLA or 4HPLA or ILA) in drinking water at concentrations in range (0.25 mg/mL) of optimized fermented food conditions as described by Kasperek et al. Food Chemistry 2024 Oct. 1:454:139798 (2024). Mice were randomized again to a control diet (CD; 10% Kcal Fat) or High Fat Diet (HFD; 45% Kcal Fat) for 10 wks. The mice were tested for glucose tolerance (GTT), were imaged with an Echo MRI, and then tissue was collected. See FIG. 10A. FIG. 10B left panel shows body weight (% baseline weight) across aryl-lactate+diet treatment. FIG. 10B right panel shows percent body weight change at D60. FIG. 10C shows percent of mice on the control diet verses the high fat diet. FIG. 10D shows the percent fat mass of mice on the control diet versus the high fat diet as determined by Echo MRI at D56. FIG. 10E shows the oral glucose tolerance test at D60. FIG. 10E right panel shows glucose area under the curve (AUC). *p<0.05.

When microbial-derived Aryl-lactates (4HPLA and ILA) are provided in drinking water at concentrations approximating the concentrations in the optimized fermented food conditions, these compounds can limit high fat diet induced: 1) weight gain (4HPLA) 2) body composition deficits (4HPLA and ILA) and 3) glucose intolerance (4HPLA). These findings provide rationale that fermented foods can exert metabolic control through aryl-lactates.

### Example 5

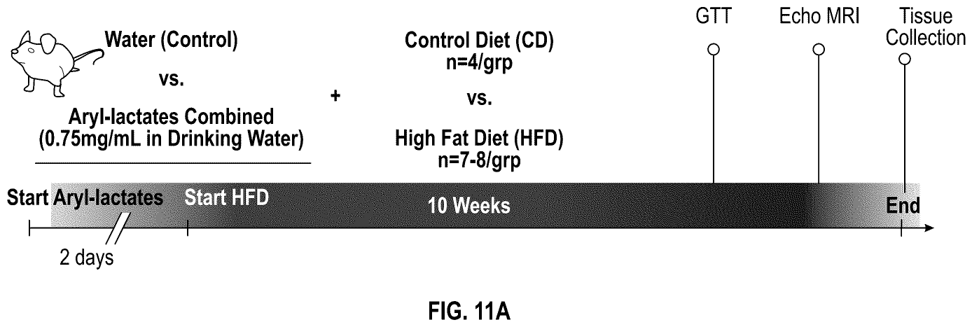

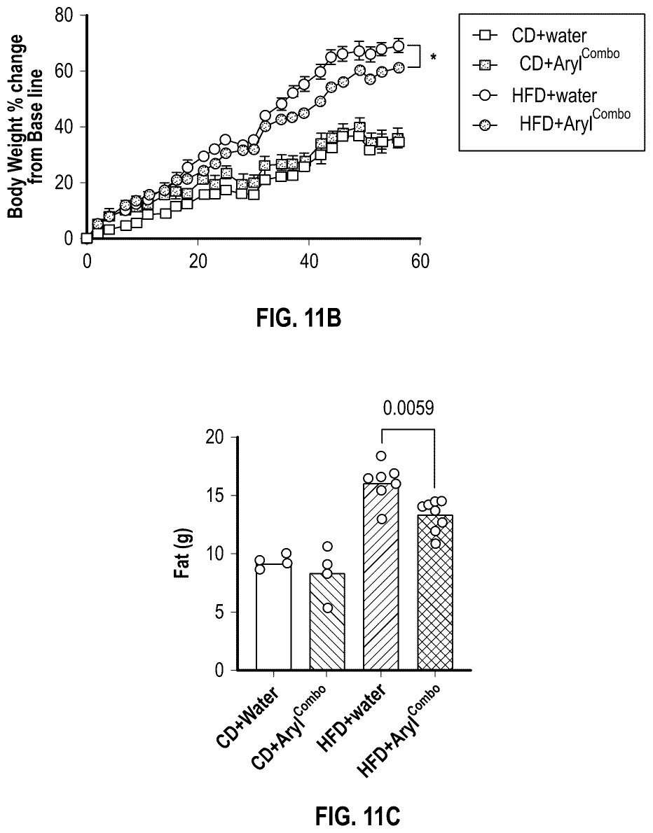

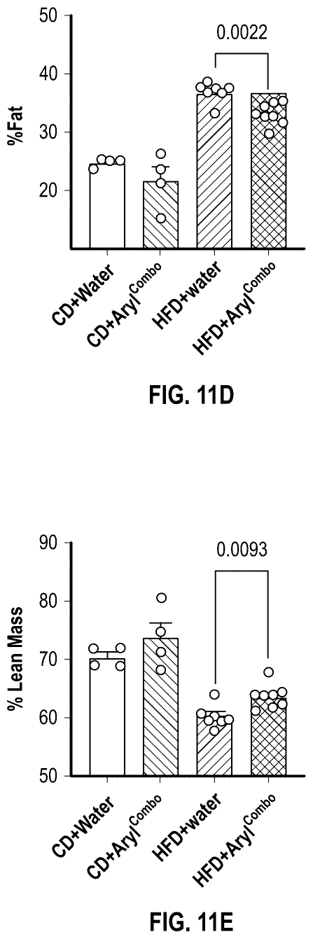

Aryl-lactate concentrations were provided in drinking water in combination (to mice at concentrations in range (0.75 mg/mL) of total aryl-lactates (Aryl^{Comb}: PLA+4HPLA+ILA) within our optimized fermented food conditions as described by Kasperek et al. Food Chemistry 2024 Oct. 1:454:139798 (FIG. 11A). FIG. 11B shows percent body weight change at post aryl-lactate+diet treatment FIG. 11C shows body fat (g) at 8 wk. FIG. 11D-E show body fat and lean mass at 8 wk.

When microbial-derived Aryl-lactates (PLA+4HPLA+ILA) are provided in drinking water together at concentrations similar to the optimized fermented food conditions, these compounds can limit high fat diet induced: 1) weight gain and body composition changes (fat deposition).

### REFERENCES

ADDIN EN.REFLIST Ayivi, R. D., Gyawali, R., Krastanov, A., Aljaloud, S. O., Worku, M., Tahergorabi, R., Silva, R. C. D., & Ibrahim, S. A. (2020). Lactic Acid Bacteria: Food Safety and Human Health Applications. Dairy, 1(3), 202-232.
Bove, P., Russo, P., Capozzi, V., Gallone, A., Spano, G., & Fiocco, D. (2013). Lactobacillus plantarum passage through an oro-gastro-intestinal tract simulator: carrier matrix effect and transcriptional analysis of genes associated to stress and probiosis. Microbiol Res, 168(6), 351-359.
Cavanagh, D., Casey, A., Altermann, E., Cotter, P. D., Fitzgerald, G. F., & McAuliffe, O. (2015). Evaluation of Lactococcus lactis Isolates from Nondairy Sources with Potential Dairy Applications Reveals Extensive Phenotype-Genotype Disparity and Implications for a Revised Species. Appl Environ Microbiol, 81(12), 3961-3972.
Chichlowski, M., Shah, N., Wampler, J. L., Wu, S. S., & Vanderhoof, J. A. (2020). Bifidobacterium longum Subspecies infantis (B. infantis) in Pediatric Nutrition: Current State of Knowledge. Nutrients, 12(6), 1581.
Dallagnol, A. M., Catalán, C. A. N., Mercado, M. I., Font De Valdez, G., & Rollán, G. C. (2011a). Effect of biosynthetic intermediates and citrate on the phenyllactic and hydroxyphenyllactic acids production by Lactobacillus plantarum CRL 778. Journal of Applied Microbiology, 111(6), 1447-1455.
Dallagnol, A. M., Catalán, C. A. N., Mercado, M. I., Font De Valdez, G., & Rollán, G. C. (2011 b). Effect of biosynthetic intermediates and citrate on the phenyllactic and hydroxyphenyllactic acids production by Lactobacillus plantarum CRL 778. Journal of Applied Microbiology, 111(6), 1447-1455.
David, L. A., Maurice, C. F., Carmody, R. N., Gootenberg, D. B., Button, J. E., Wolfe, B. E., Ling, A. V., Devlin, A. S., Varma, Y., Fischbach, M. A., Biddinger, S. B., Dutton, R. J., & Turnbaugh, P. J. (2014). Diet rapidly and reproducibly alters the human gut microbiome. Nature, 505(7484), 559-563.
Dimidi, E., Cox, S. R., Rossi, M., & Whelan, K. (2019). Fermented Foods: Definitions and Characteristics, Impact on the Gut Microbiota and Effects on Gastrointestinal Health and Disease. Nutrients, 11(8), 1806.
Dodd, D., Spitzer, M. H., Van Treuren, W., Merrill, B. D., Hryckowian, A. J., Higginbottom, S. K., Le, A., Cowan, T. M., Nolan, G. P., Fischbach, M. A., & Sonnenburg, J. L. (2017). A gut bacterial pathway metabolizes aromatic amino acids into nine circulating metabolites. Nature, 551(7682), 648-652.
Ehrlich, A. M., Pacheco, A. R., Henrick, B. M., Taft, D., Xu, G., Huda, M. N., Mishchuk, D., Goodson, M. L., Slupsky, C., Barile, D., Lebrilla, C. B., Stephensen, C. B., Mills, D. A., & Raybould, H. E. (2020). Indole-3-lactic acid associated with Bifidobacterium-dominated microbiota significantly decreases inflammation in intestinal epithelial cells. BMC Microbiol, 20(1), 357.
Ehrlich, A. M., Pacheco, A. R., Henrick, B. M., Taft, D., Xu, G., Huda, M. N., Mishchuk, D., Goodson, M. L., Slupsky, C., Barile, D., Lebrilla, C. B., Stephensen, C. B., Mills, D. A., & Raybould, H. E. (2020). Indole-3-lactic acid associated with Bifidobacterium-dominated microbiota significantly decreases inflammation in intestinal epithelial cells. BMC Microbiology, 20(1).
Guimarães, A., Santiago, A., Teixeira, J. A., Venâncio, A., & Abrunhosa, L. (2018). Anti-aflatoxigenic effect of organic acids produced by Lactobacillus plantarum. International Journal of Food Microbiology, 264, 31-38.
Guimarães, A., Venancio, A., & Abrunhosa, L. (2018). Antifungal effect of organic acids from lactic acid bacteria on <i>Penicillium nordicum</i>. Food Additives &amp; Contaminants: Part A, 35(9), 1803-1818.
Huang, W., Cho, K. Y., Meng, D., & Walker, W. A. (2021). The impact of indole-3-lactic acid on immature intestinal innate immunity and development: a transcriptomic analysis. Scientific Reports, 11(1).
Kasperek, M. C., Mailing, L., Piccolo, B. D., Moody, B., Lan, R., Gao, X., Hernandez-Saavedra, D., Woods, J. A., Adams, S. H., & Allen, J. M. (2023). Exercise training modifies xenometabolites in gut and circulation of lean and obese adults. Physiological Reports, 11(6).
Kim, E., Yang, S.-M., Lim, B., Park, S. H., Rackerby, B., & Kim, H.-Y. (2020). Design of PCR assays to specifically detect and identify 37 Lactobacillus species in a single 96 well plate. BMC Microbiology, 20(1).
Kim, J., Choi, K.-B., Park, J. H., & Kim, K. H. (2019). Metabolite profile changes and increased antioxidative and antiinflammatory activities of mixed vegetables after fermentation by Lactobacillus plantarum. PLOS ONE, 14(5), e0217180.
Lamas, B., Richard, M. L., & Sokol, H. (2017). Caspase recruitment domain 9, microbiota, and tryptophan metabolism: dangerous liaisons in inflammatory bowel diseases. Curr Opin Clin Nutr Metab Care, 20(4), 243-247.
Laurans, L., Venteclef, N., Haddad, Y., Chajadine, M., Alzaid, F., Metghalchi, S., Sovran, B., Denis, R. G. P., Dairou, J., Cardellini, M., Moreno-Navarrete, J. M., Straub, M., Jegou, S., McQuitty, C., Viel, T., Esposito, B., Tavitian, B., Callebert, J., Luquet, S. H., . . . Taleb, S. (2018). Genetic deficiency of indoleamine 2,3-dioxygenase promotes gut microbiota-mediated metabolic health. Nat Med, 24(8), 1113-1120.
Laursen, M. F., Sakanaka, M., Von Burg, N., Mörbe, U., Andersen, D., Moll, J. M., Pekmez, C. T., Rivollier, A., Michaelsen, K. F., Molgaard, C., Lind, M. V., Dragsted, L. O., Katayama, T., Frandsen, H. L., Vinggaard, A. M., Bahl, M. I., Brix, S., Agace, W., Licht, T. R., & Roager, H. M. (2021). Bifidobacterium species associated with breastfeeding produce aromatic lactic acids in the infant gut. Nature Microbiology, 6(11), 1367-1382.
Li, K. J., Brouwer-Brolsma, E. M., Burton-Pimentel, K. J., Vergères, G., & Feskens, E. J. M. (2021). A systematic review to identify biomarkers of intake for fermented food products. Genes & amp; Nutrition, 16(1).
Li, X., Ning, Y., Liu, D., Yan, A., Wang, Z., Wang, S., Miao, M., Zhu, H., & Jia, Y. (2015). Metabolic mechanism of phenyllactic acid naturally occurring in Chinese pickles. Food Chem, 186, 265-270.
Marco, M. L., Sanders, M. E., Gänzle, M., Arrieta, M. C., Cotter, P. D., De Vuyst, L., Hill, C., Holzapfel, W., Lebeer, S., Merenstein, D., Reid, G., Wolfe, B. E., & Hutkins, R. (2021a). The International Scientific Association for Probiotics and Prebiotics (ISAPP) consensus statement on fermented foods. Nature Reviews Gastroenterology &amp; Hepatology, 18(3), 196-208.
Marco, M. L., Sanders, M. E., Gänzle, M., Arrieta, M. C., Cotter, P. D., De Vuyst, L., Hill, C., Holzapfel, W., Lebeer, S., Merenstein, D., Reid, G., Wolfe, B. E., & Hutkins, R. (2021 b). The International Scientific Association for Probiotics and Prebiotics (ISAPP) consensus statement on fermented foods. Nature Reviews Gastroenterology &amp; Hepatology, 18(3), 196-208.
Mathur, H., Beresford, T. P., & Cotter, P. D. (2020). Health Benefits of Lactic Acid Bacteria (LAB) Fermentates. Nutrients, 12(6).
Meng, D., Sommella, E., Salviati, E., Campiglia, P., Ganguli, K., Djebali, K., Zhu, W., & Walker, W. A. (2020a). Indole-3-lactic acid, a metabolite of tryptophan, secreted by Bifidobacterium longum subspecies infantis is anti-inflammatory in the immature intestine. Pediatric Research, 88(2), 209-217.
Meng, D., Sommella, E., Salviati, E., Campiglia, P., Ganguli, K., Djebali, K., Zhu, W., & Walker, W. A. (2020b). Indole-3-lactic acid, a metabolite of tryptophan, secreted by Bifidobacterium longum subspecies infantis is anti-inflammatory in the immature intestine. Pediatric Research, 88(2), 209-217.
Montgomery, T. L., Eckstrom, K., Lile, K. H., Caldwell, S., Heney, E. R., Lahue, K. G., D'Alessandro, A., Wargo, M. J., & Krementsov, D. N. (2022). Lactobacillus reuteri tryptophan metabolism promotes host susceptibility to CNS autoimmunity. Microbiome, 10(1).
O'Brien, C. E., Meier, A. K., Cernioglo, K., Mitchell, R. D., Casaburi, G., Frese, S. A., Henrick, B. M., Underwood, M. A., & Smilowitz, J. T. (2022). Early probiotic supplementation with B. infantis in breastfed infants leads to persistent colonization at 1 year. Pediatric Research, 91(3), 627-636.
Pan, T., Pei, Z., Fang, Z., Wang, H., Zhu, J., Zhang, H., Zhao, J., Chen, W., & Lu, W. (2023). Uncovering the specificity and predictability of tryptophan metabolism in lactic acid bacteria with genomics and metabolomics. Front Cell Infect Microbiol, 13, 1154346.
Peters, A., Krumbholz, P., Jager, E., Heintz-Buschart, A., Cakir, M. V., Rothemund, S., Gaudl, A., Ceglarek, U., Schoneberg, T., & Staubert, C. (2019). Metabolites of lactic acid bacteria present in fermented foods are highly potent agonists of human hydroxycarboxylic acid receptor 3. PLoS Genet, 15(5), el008145.
Peters, A., Krumbholz, P., Jäger, E., Heintz-Buschart, A., Çakir, M. V., Rothemund, S., Gaudl, A., Ceglarek, U., Schöneberg, T., & Stäubert, C. (2019). Metabolites of lactic acid bacteria present in fermented foods are highly potent agonists of human hydroxycarboxylic acid receptor 3. PLOS Genetics, 15(5), el008145.
Rajendran, S., Silcock, P., & Bremer, P. (2023). Flavour Volatiles of Fermented Vegetable and Fruit Substrates: A Review. Molecules, 28(7), 3236.
Rezac, S., Kok, C. R., Heermann, M., & Hutkins, R. (2018). Fermented Foods as a Dietary Source of Live Organisms. Front Microbiol, 9, 1785.
Richard van Kranenburg, M. K., Johan van Hylckama Vlieg, Bjorn M Ursing, Jos Boekhorst, Bart A Smit, Eman H E Ayad, Gerrit Smit, Roland J Siezen. (2002). Flavour formation from amino acids by lactic acid bacteria: predictions from genome sequence analysis. Int Dairy J, 12, 111-121.
Singh, R. K., Chang, H.-W., Yan, D., Lee, K. M., Ucmak, D., Wong, K., Abrouk, M., Farahnik, B., Nakamura, M., Zhu, T. H., Bhutani, T., & Liao, W. (2017). Influence of diet on the gut microbiome and implications for human health. Journal of Translational Medicine, 15(1).
Stockinger, B., Shah, K., & Wincent, E. (2021). AHR in the intestinal microenvironment: safeguarding barrier function. Nature Reviews Gastroenterology &amp; Hepatology, 18(8), 559-570.
Sun, D., Li, H., Song, D., Zhang, L., Zhao, X., & Xu, X. (2019). Genome, transcriptome and fermentation analyses of Lactobacillus plantarum LY-78 provide new insights into the mechanism of phenyllactate biosynthesis in lactic acid bacteria. Biochem Biophys Res Commun, 519(2), 351-357.
Suzuki, Y., Kosaka, M., Shindo, K., Kawasumi, T., Kimoto-Nira, H., & Suzuki, C. (2013a). Identification of Antioxidants Produced by<i>Lactobacillus plantarum</i>. Bioscience, Biotechnology, and Biochemistry, 77(6), 1299-1302.
Suzuki, Y., Kosaka, M., Shindo, K., Kawasumi, T., Kimoto-Nira, H., & Suzuki, C. (2013b). Identification of Antioxidants Produced by<i>Lactobacillus plantarum</i>. Bioscience, Biotechnology, and Biochemistry, 77(6), 1299-1302.
Tan, W. C., Muhialdin, B. J., & Meor Hussin, A. S. (2020). Influence of Storage Conditions on the Quality, Metabolites, and Biological Activity of Soursop (Annona muricata. L.) Kombucha. Front Microbiol, 11, 603481.
Tejedor-Sanz, S., Stevens, E. T., Li, S., Finnegan, P., Nelson, J., Knoesen, A., Light, S. H., Ajo-Franklin, C. M., & Marco, M. L. (2022). Extracellular electron transfer increases fermentation in lactic acid bacteria via a hybrid metabolism. Elife, 11.
Varsha, K. K., Narisetty, V., Brar, K. K., Madhavan, A., Alphy, M. P., Sindhu, R., Awasthi, M. K., Varjani, S., & Binod, P. (2023). Bioactive metabolites in functional and fermented foods and their role as immunity booster and anti-viral innate mechanisms. Journal of Food Science and Technology, 60(9), 2309-2318.
Vatanen, T., Ang, Q. Y., Siegwald, L., Sarker, S. A., Le Roy, C. I., Duboux, S., Delannoy-Bruno, O., Ngom-Bru, C., Boulange, C. L., Strazar, M., Avila-Pacheco, J., Deik, A., Pierce, K., Bullock, K., Dennis, C., Sultana, S., Sayed, S., Rahman, M., Ahmed, T., . . . Xavier, R. J. (2022). A distinct clade of Bifidobacterium longum in the gut of Bangladeshi children thrives during weaning. Cell, 185(23), 4280-4297 e4212.
Wang, Y., Wu, J., Lv, M., Shao, Z., Hungwe, M., Wang, J., Bai, X., Xie, J., Wang, Y., & Geng, W. (2021). Metabolism Characteristics of Lactic Acid Bacteria and the Expanding Applications in Food Industry. Front Bioeng Biotechnol, 9, 612285.
Wastyk, H. C., Fragiadakis, G. K., Perelman, D., Dahan, D., Merrill, B. D., Yu, F. B., Topf, M., Gonzalez, C. G., Van Treuren, W., Han, S., Robinson, J. L., Elias, J. E., Sonnenburg, E. D., Gardner, C. D., & Sonnenburg, J. L. (2021a). Gut-microbiota-targeted diets modulate human immune status. Cell, 184(16), 4137-4153 e4114.
Wastyk, H. C., Fragiadakis, G. K., Perelman, D., Dahan, D., Merrill, B. D., Yu, F. B., Topf, M., Gonzalez, C. G., Van Treuren, W., Han, S., Robinson, J. L., Elias, J. E., Sonnenburg, E. D., Gardner, C. D., & Sonnenburg, J. L. (2021b). Gut-microbiota-targeted diets modulate human immune status. Cell, 184(16), 4137-4153 e4114.
Yilmaz, B., Bangar, S. P., Echegaray, N., Suri, S., Tomasevic, I., Manuel Lorenzo, J., Melekoglu, E., Rocha, J. M., & Ozogul, F. (2022). The Impacts of Lactiplantibacillus plantarum on the Functional Properties of Fermented Foods: A Review of Current Knowledge. Microorganisms, 10(4), 826.
Zhang, Q., Zhao, Q., Li, T., Lu, L., Wang, F., Zhang, H., Liu, Z., Ma, H., Zhu, Q., Wang, J., Zhang, X., Pei, Y., Liu, Q., Xu, Y., Qie, J., Luan, X., Hu, Z., & Liu, X. (2023). Lactobacillus plantarum-derived indole-3-lactic acid ameliorates colorectal tumorigenesis via epigenetic regulation of CD8(+) T cell immunity. Cell Metab, 35(6), 943-960 e949.
Zhang, Q., Zhao, Q., Li, T., Lu, L., Wang, F., Zhang, H., Liu, Z., Ma, H., Zhu, Q., Wang, J., Zhang, X., Pei, Y., Liu, Q., Xu, Y., Qie, J., Luan, X., Hu, Z., & Liu, X. (2023). Lactobacillus plantarum-derived indole-3-lactic acid ameliorates colorectal tumorigenesis via epigenetic regulation of CD8+ T cell immunity. Cell Metabolism, 35(6), 943-960.e949.

1. A method of increasing aryl-lactates in a fermented food matrix comprising adding:
(a) alpha-ketoglutarate (AKG), trisodium citrate dehydrate (CIT), or both AKG and CIT; or
(b) phenylpyruvic acid (PPyA), 4-hydroxyphenylpyruvic acid (4HPPyA), indole-3-pyruvic acid (IPyA), or combinations thereof;
(c) phenylalanine (Phe), tyrosine (Tyr), tryptophan (Trp), or combinations thereof; or
(d) combinations of (a), (b), and (c)
to:
(i) a pre-fermentation food matrix and allowing the pre-fermentation food matrix to ferment to form a fermented food matrix having increased amounts of aryl-lactates in comparison to a control;
(ii) a pre-fermentation food matrix after the beginning of fermentation and allowing the pre-fermentation food matrix to ferment to form a fermented food matrix having increased amounts of aryl-lactates in comparison to a control; or
(iii) to a fermented food matrix after the end of fermentation to form a fermented food matrix having increased amounts of aryl-lactates in comparison to a control.

2. The method of claim 1, wherein the aryl-lactates comprise phenyllactic acid (PLA), 4-hydroxyphenyllactic acid (4-HPLA), indole-lactic acid (ILA), or combinations thereof.

3. The method of claim 1, wherein the PPyA, 4HPPyA, IPyA, or combinations are added at an amount of 0.5-5 mM.

4. The method of claim 1, wherein the AKG, CIT, or both are added at an amount of 0.5-5 mM.

5. The method of claim 1, wherein the Phe, Tyr, Trp, or combinations are added at an amount of 0.5-5 mM.

6. The method of claim 1, further comprising adding one or more bacterial strains having aromatic amino transferase (ArAT) activity and/or phenyllactate dehydrogenase (fLDH) activity.

7. (canceled)

8. (canceled)

9. (canceled)

10. The method of claim 6, wherein the one or more bacterial strains are Lactiplantibacillus plantarum, Lactobacillus rhamnosus, Lactobacillus paraplantarum, Lactobacillus brevis, Bifidobacterium infantis, Lacticaseibacillus paracasei, or combinations thereof.

11. (canceled)

12. (canceled)

13. The method of claim 1, wherein the pre-fermentation food matrix is a dairy product, vegetables, beans, grains, fruit, tea, fish, or meat.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. A fermented food product produced by adding:
(a) alpha-ketoglutarate (AKG), trisodium citrate dehydrate (CIT), or both AKG and CIT;
(b) phenylpyruvic acid (PPyA), 4-hydroxyphenylpyruvic acid (4HPPyA), indole-3-pyruvic acid (IPyA), or combinations thereof;
(c) phenylalanine (Phe), tyrosine (Tyr), tryptophan (Trp), or combinations thereof; or
(d) combinations of (a), (b), and (c)
to:
(i) a pre-fermentation food matrix before or during fermentation and allowing the pre-fermentation food matrix to ferment to form a fermented food product; or
(ii) a fermented food matrix to form a fermented food product.

28. The fermented food product of claim 27, wherein the aryl-lactates comprise PLA, 4-HPLA, ILA, or combinations thereof.

29. The fermented food product of claim 27, wherein PPyA, 4HPPyA, IPyA, or combinations are added at an amount of 0.5-5 mM or the AKG, CIT, or both are added at an amount of 0.5-5 mM.

30. (canceled)

31. The fermented food product of claim 27, wherein one or more bacterial strains having aromatic amino transferase (ArAT) activity and/or phenyllactate dehydrogenase (fLDH) activity are added to the pre-fermentation food matrix.

32. (canceled)

33. (canceled)

34. (canceled)

35. The fermented food product of claim 31, wherein the one or more bacterial strains are Lactiplantibacillus plantarum, Lactobacillus rhamnosus, Lactobacillus paraplantarum, Lactobacillus brevis, Bifidobacterium infantis, Lacticaseibacillus paracasei, or combinations thereof.

36. (canceled)

37. The fermented food product of claim 27, wherein the pre-fermentation food matrix is a dairy product, vegetables, beans, grains, fruit, tea, fish, or meat.

38. A method of inducing weight loss, reducing fat mass, and/or reducing glucose intolerance in an overweight or obese mammal comprising feeding 200 g or more of the fermented food product of claim 27 to the overweight or obese mammal daily for a period of a month or more.

39. (canceled)

40. A pre-fermentation food matrix comprising a food matrix and:
(a) added alpha-ketoglutarate (AKG), trisodium citrate dehydrate (CIT), or both AKG and CIT; or
(b) added phenylpyruvic acid (PPyA), 4-hydroxyphenylpyruvic acid (4HPPyA), indole-3-pyruvic acid (IPyA), or combinations thereof; or
(c) added phenylalanine (Phe), tyrosine (Tyr), tryptophan (Trp), or combinations thereof; or
(d) combinations of (a), (b), and (c).

41. The pre-fermentation food matrix of claim 40, wherein the aryl-lactates comprise phenyllactic acid (PLA), 4-hydroxyphenyllactic acid (4-HPLA), indole-lactic acid (ILA), or combinations thereof.

42. The pre-fermentation food matrix of claim 40, wherein the PPyA, 4HPPyA, IPyA, or combinations are added at an amount of 0.5-5 mM or the AKG, CIT, or both are added at an amount of 0.5-5 mM.

43. (canceled)

44. The pre-fermentation food matrix of claim 40, wherein the pre-fermentation food matrix further comprises one or more added bacterial strains having aromatic amino transferase (ArAT) activity and/or phenyllactate dehydrogenase (fLDH) activity.

45. (canceled)

46. (canceled)

47. (canceled)

47. The pre-fermentation food matrix of claim 44, wherein the one or more bacterial strains are Lactiplantibacillus plantarum, Lactobacillus rhamnosus, Lactobacillus paraplantarum, Lactobacillus brevis, Bifidobacterium infantis, Lacticaseibacillus paracasei, or combinations thereof.

49. (canceled)

50. (canceled)

51. (canceled)

52. (canceled)

53. (canceled)

54. (canceled)

55. (canceled)
